(19) United States
(12) Patent Application Publication
(10) Pub. No.: US 2026/0220398 A1
(43) Pub. Date: Jul. 30, 2026

(54) DUPLICATION AVOIDANCE SCHEMES IN PASSIVE UE DATA DELIVERY

(71) Applicant: QUALCOMM Incorporated, San Diego, CA (US)

(72) Inventors: Kangqi LIU, San Diego, CA (US); Chao WEI, Beijing (CN); Ruiming ZHENG, Beijing (CN); Min HUANG, Beijing (CN); Hao XU, Beijing (CN)

(21) Appl. No.: 19/143,320

(22) PCT Filed: Feb. 10, 2023
(86) PCT No.: PCT/CN2023/075344

§ 371 Date: Jun. 26, 2025

(51) Int. Cl. G06K 7/016; H04W 4/80

(52) U.S. Cl. CPC G06K 7/016; H04W 4/80

(57) ABSTRACT

Methods, systems, and devices for duplication avoidance scheme in passive user equipment (UE) data delivery are described. A first backscatter reading device may monitor for backscatter data from multiple passive UEs, one or more additional backscatter reading devices, or both. The first backscatter reading device may receive backscatter data message from passive UEs via a second backscatter reading device, and relay the message to a network entity after removing duplicates. In some other examples, a first backscatter reading device may receive backscatter data messages from one or more passive UEs, and monitor for feedback signaling corresponding to the backscatter data messages from a network entity. The first backscatter reading device may forward the backscatter data messages based on the control signaling.

### CROSS REFERENCE

The present Application is a 371 national phase filing of International PCT Application No. PCT/CN2023/075344 by LIU et al., entitled “DUPLICATION AVOIDANCE SCHEMES IN PASSIVE UE DATA DELIVERY,” filed Feb. 10, 2023, which is assigned to the assignee hereof, and which is expressly incorporated by reference in its entirety herein.

### TECHNICAL FIELD

The following relates to wireless communications, including duplication avoidance schemes in passive UE data delivery.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

Some wireless communications systems may support passive Internet of Things (IoT) systems. The following relates to wireless communications, including system applications and data transmission for passive IoT systems.

### SUMMARY

The described techniques relate to improved methods, systems, devices, and apparatuses that support duplication avoidance schemes in passive UE data delivery. For example, the described techniques provide for reducing duplication of backscatter data relay. In some examples, a backscatter reading device (e.g., a UE, network entity), may be designated as a primary backscatter reading device for backscatter data collection and relaying. The primary backscatter reading device may collect the backscatter data from one or more additional backscatter reading devices and one or more passive UEs. The primary backscatter reading device may discard duplicated messages, and then relay the backscatter data to another device, one or more passive UEs, or a combination thereof. In some examples, a network entity may multicast feedback to backscatter reading devices to indicate which backscatter data messages have already been received. One or more backscatter reading devices may receive backscatter data from one or more passive UEs, and relay data to the network entity based on feedback messages from the network entity. The feedback message from the network entity may be multicast feedback to the backscatter reading devices including identifiers (IDs) of passive UEs of received data. If the backscatter reading device receives the same backscatter data from a passive UE (based on the passive UE ID) the backscatter reading device will not relay the backscatter data, thus avoiding duplication. In some examples, a network entity may be designated as a primary backscatter reading device for backscatter data collection. A network entity may transmit a request to the radio frequency source device, and the radio frequency source may trigger transmission of backscatter data by one or more passive UEs. The primary backscatter reading device may fail to receive some or all of the backscatter data, and may send a message to one or more other backscatter reading devices to request any missing passive UE backscatter data. The one or more additional backscatter reading device may respond to the request with any missing backscatter data.

A method for wireless communications at a first backscatter reading device is described. The method may include monitoring for backscatter data from a set of multiple passive user equipments (UEs), one or more additional backscatter reading devices, or both, receiving, based on the monitoring, a first backscatter data message from a first passive user equipment (UE) of the set of multiple passive UEs via a second backscatter reading device of the one or more additional backscatter reading devices, and relaying the first backscatter data message to a network entity.

An apparatus for wireless communications at a first backscatter reading device is described. The apparatus may include a processor, memory coupled with the processor, and instructions stored in the memory. The instructions may be executable by the processor (e.g., directly, indirectly, after pre-processing, without pre-processing) to cause the apparatus to monitor for backscatter data from a set of multiple passive UEs, one or more additional backscatter reading devices, or both, receive, based on the monitoring, a first backscatter data message from a first passive UE of the set of multiple passive UEs via a second backscatter reading device of the one or more additional backscatter reading devices, and relay the first backscatter data message to a network entity.

Another apparatus for wireless communications at a first backscatter reading device is described. The apparatus may include means for monitoring for backscatter data from a set of multiple passive user equipments (UEs), one or more additional backscatter reading devices, or both, means for receiving, based on the monitoring, a first backscatter data message from a first passive UE of the set of multiple passive UEs via a second backscatter reading device of the one or more additional backscatter reading devices, and means for relaying the first backscatter data message to a network entity.

A non-transitory computer-readable medium storing code for wireless communications at a first backscatter reading device is described. The code may include instructions executable by the at least one processor (e.g., directly, indirectly, after pre-processing, without pre-processing) to monitor for backscatter data from a set of multiple passive user equipments (UEs), one or more additional backscatter reading devices, or both, receive, based on the monitoring, a first backscatter data message from a first passive UE of the set of multiple passive UEs via a second backscatter reading device of the one or more additional backscatter reading devices, and relay the first backscatter data message to a network entity.

Some examples of the method, apparatuses, and non-transitory computer-readable medium described herein may further include operations, features, means, or instructions for receiving, from one or more of the set of multiple passive UEs or the one or more additional backscatter reading devices based on the monitoring, a set of multiple backscatter data messages, where at least one of the set of multiple backscatter data messages includes a duplicate of the first backscatter data message and discarding the duplicate of the first backscatter data message, where relaying the first backscatter data message to the network entity may be based on the discarding, where the first backscatter reading device includes a first UE and the second backscatter reading device includes a second UE.

Some examples of the method, apparatuses, and non-transitory computer-readable medium described herein may further include operations, features, means, or instructions for combining one or more parameters associated with the first backscatter data message and the duplicate of the first backscatter data message for joint decoding by the first backscatter reading device, where relaying the first backscatter data message to the network entity may be based on the combining.

Some examples of the method, apparatuses, and non-transitory computer-readable medium described herein may further include operations, features, means, or instructions for receiving, from the network entity, control signaling indicating that the first backscatter reading device may be a primary backscatter reading device, where receiving the first backscatter data message via the second backscatter reading device may be based on the control signaling indicating that the first backscatter reading device may be a primary backscatter reading device.

In some examples of the method, apparatuses, and non-transitory computer-readable medium described herein, receiving the first backscatter data message from the first passive UE via the second backscatter reading device may include operations, features, means, or instructions for receiving, from the second backscatter reading device, an indication of a set of multiple backscatter data messages received by the second backscatter reading device, the indication further indicating a quantity of passive UEs corresponding to the set of multiple backscatter data messages, where the set of multiple backscatter data messages includes the first backscatter data message.

Some examples of the method, apparatuses, and non-transitory computer-readable medium described herein may further include operations, features, means, or instructions for transmitting, to the network entity, a request to switch the second backscatter reading device to be a primary backscatter reading device responsive to the quantity of passive UEs corresponding to the set of multiple backscatter data messages received by the second backscatter reading device being greater than a second quantity of backscatter data messages received by the first backscatter reading device.

Some examples of the method, apparatuses, and non-transitory computer-readable medium described herein may further include operations, features, means, or instructions for transmitting, to a set of multiple additional backscatter reading device including the second backscatter reading device, an indication of one or more identifiers associated with respective passive UEs of the quantity of passive UEs corresponding to the set of multiple backscatter data messages.

Some examples of the method, apparatuses, and non-transitory computer-readable medium described herein may further include operations, features, means, or instructions for transmitting, to the second backscatter reading device based on the monitoring, a request for the first backscatter data message, where receiving the first backscatter data message from the second backscatter reading device may be based on transmitting the request.

Some examples of the method, apparatuses, and non-transitory computer-readable medium described herein may further include operations, features, means, or instructions for transmitting, to at least the first passive UE via a radio frequency source device, control signaling including an instruction to transmit the first backscatter data message, initiating a timer upon transmitting the control signaling, and monitoring for the first backscatter data message based on transmitting the control signaling, where transmitting the request for the first backscatter data message may be based at least in part upon expiration of the timer.

In some examples of the method, apparatuses, and non-transitory computer-readable medium described herein, the first backscatter reading device includes a first network entity, and the second backscatter reading device includes a second network entity.

A method for wireless communications at a first backscatter reading device is described. The method may include receiving control signaling indicating that the first backscatter reading device is to monitor for backscatter data from a set of multiple passive user equipments (UEs), receiving a set of multiple backscatter data messages from one or more passive UEs based on receiving the control signaling, monitoring for feedback signaling, from a network entity, corresponding to one or more of the set of multiple backscatter data messages, and forwarding at least a first backscatter data message of the set of multiple backscatter data messages to the network entity based on the monitoring.

An apparatus for wireless communications at a first backscatter reading device is described. The apparatus may include a processor, memory coupled with the processor, and instructions stored in the memory. The instructions may be executable by the processor (e.g., directly, indirectly, after pre-processing, without pre-processing) to cause the apparatus to receive control signaling indicating that the first backscatter reading device is to monitor for backscatter data from a set of multiple passive user equipments (UEs), receive a set of multiple backscatter data messages from one or more passive UEs based on receiving the control signaling, monitor for feedback signaling, from a network entity, corresponding to one or more of the set of multiple backscatter data messages, and forward at least a first backscatter data message of the set of multiple backscatter data messages to the network entity based on the monitoring.

Another apparatus for wireless communications at a first backscatter reading device is described. The apparatus may include means for receiving control signaling indicating that the first backscatter reading device is to monitor for backscatter data from a set of multiple passive user equipments (UEs), means for receiving a set of multiple backscatter data messages from one or more passive UEs based on receiving the control signaling, means for monitoring for feedback signaling, from a network entity, corresponding to one or more of the set of multiple backscatter data messages, and means for forwarding at least a first backscatter data message of the set of multiple backscatter data messages to the network entity based on the monitoring.

A non-transitory computer-readable medium storing code for wireless communications at a first backscatter reading device is described. The code may include instructions executable by a processor (e.g., directly, indirectly, after pre-processing, without pre-processing) to receive control signaling indicating that the first backscatter reading device is to monitor for backscatter data from a set of multiple passive user equipments (UEs), receive a set of multiple backscatter data messages from one or more passive UEs based on receiving the control signaling, monitor for feedback signaling, from a network entity, corresponding to one or more of the set of multiple backscatter data messages, and forward at least a first backscatter data message of the set of multiple backscatter data messages to the network entity based on the monitoring.

Some examples of the method, apparatuses, and non-transitory computer-readable medium described herein may further include operations, features, means, or instructions for receiving, based on the monitoring, a first feedback message from the network entity indicating that the network entity may have successfully received a second backscatter data message of the set of multiple backscatter data messages and discarding the second backscatter data message of the set of multiple backscatter data messages based on the first feedback message.

In some examples of the method, apparatuses, and non-transitory computer-readable medium described herein, the first feedback message includes a device identifier corresponding to a first passive UE of the set of multiple passive UEs and the discarding may be based on receiving the device identifier.

Some examples of the method, apparatuses, and non-transitory computer-readable medium described herein may further include operations, features, means, or instructions for receiving, based on the monitoring, a set of multiple feedback messages, each feedback message corresponding to a device identifier of a respective passive UE of the set of multiple passive UEs and determining that none of the received feedback messages indicate a device identifier associated with the first backscatter data message, where transmitting the first backscatter data message may be based on the determining.

In some examples of the method, apparatuses, and non-transitory computer-readable medium described herein, the first backscatter reading device includes a UE.

In some examples of the method, apparatuses, and non-transitory computer-readable medium described herein, the control signaling includes multicast control signaling for a set of multiple backscatter reading devices including the first backscatter reading device.

In some examples of the method, apparatuses, and non-transitory computer-readable medium described herein, the control signaling includes unicast control signaling for the first backscatter reading device.

### BRIEF DESCRIPTION OF THE DRAWINGS

FIG. 1 illustrates an example of a wireless communications system that supports duplication avoidance schemes in passive UE data delivery in accordance with one or more aspects of the present disclosure.

FIG. 2 illustrates an example of a wireless communications system that supports duplication avoidance schemes in passive UE data delivery in accordance with one or more aspects of the present disclosure.

FIG. 3 illustrates an example of a wireless communications system that supports duplication avoidance schemes in passive UE data delivery in accordance with one or more aspects of the present disclosure.

FIG. 4 illustrates an example of a process flow diagram that supports duplication avoidance schemes in passive UE data delivery in accordance with one or more aspects of the present disclosure.

FIG. 5 illustrates an example of a wireless communications system that supports duplication avoidance schemes in passive UE data delivery in accordance with one or more aspects of the present disclosure.

FIG. 6 illustrates an example of a process flow diagram that supports duplication avoidance schemes in passive UE data delivery in accordance with one or more aspects of the present disclosure.

FIG. 7 illustrates an example of a wireless communications system that supports duplication avoidance schemes in passive UE data delivery in accordance with one or more aspects of the present disclosure.

FIG. 8 illustrates an example of a process flow diagram that supports duplication avoidance schemes in passive UE data delivery in accordance with one or more aspects of the present disclosure.

FIGS. 9 and 10 illustrate block diagrams of devices that support duplication avoidance schemes in passive UE data delivery in accordance with one or more aspects of the present disclosure.

FIG. 11 illustrates a block diagram of a communications manager that supports duplication avoidance schemes in passive UE data delivery in accordance with one or more aspects of the present disclosure.

FIG. 12 illustrates a diagram of a system including a device that supports duplication avoidance schemes in passive UE data delivery in accordance with one or more aspects of the present disclosure.

FIGS. 13 through 17 illustrate flowcharts showing methods that support duplication avoidance schemes in passive UE data delivery in accordance with one or more aspects of the present disclosure.

### DETAILED DESCRIPTION

Some wireless communications systems (e.g., New Radio (NR) or 5G advanced systems) may support passive Internet of Things (IoT). Passive IoT systems may include devices, such as a passive user equipments (UEs) or another passive device, which have no or limited battery. Instead, the passive device accumulates energy from radio signaling (e.g., harvests energy from received radio frequency (RF) signaling). For example, a passive UE may receive a radio signal, process the signal via an energy harvester and microcontroller, and reflect the radio signal to another receiver. The reflected signal may be referred to as backscatter data. The reflected backscatter data may be multicast by the passive UE, and may be reflected by another passive UE, or may be received by one or more readers, or backscatter reading devices (e.g., a UE, a gNB, a network entity), or both. The readers may receive and decode backscatter data, and may then relay the data to the network (e.g., to or via a network entity). In some examples, one or more passive UEs may multicast the backscatter data, and multiple readers may receive and relay the same backscatter data to the core network, resulting in duplicated data messages. Relaying one or more duplicates of backscatter data may result in unnecessary increases in signaling overhead, decreased throughput and inefficient use of system resources, increased power expenditures by the readers, and increased system latency.

Techniques described herein relate to reducing duplication of backscatter data relay. In some examples, a backscatter reading device (e.g., a UE, or network entity), may be designated as a primary backscatter reading device for backscatter data collection and relaying. One or more backscatter reading devices may receive backscatter data multicast from one or more passive UEs. The primary backscatter reading device may collect the backscatter data from one or more additional backscatter reading devices (e.g., configured to forward all received backscatter messages to the primary backscatter reading device), one or more passive UEs, or a combination thereof. The primary backscatter reading device may discard duplicated messages, and then relay the backscatter data to the network (e.g., via another device such as a network entity) without duplicates.

In some examples, a network entity may multicast feedback to backscatter reading devices to indicate which backscatter data messages have already been received (e.g., resulting in preventing the backscatter reading devices from relaying backscatter data to the network entity). One or more backscatter reading devices may receive backscatter data from one or more passive UEs, and relay data to the network entity based on feedback messages from the network entity. The feedback message from the network entity may be multicast feedback to the backscatter reading devices including identifiers (IDs) of passive UEs of received data. Thus, the backscatter reading device may receive the feedback from the network entity indicating that backscatter data from a passive UE has already been received, identified via the ID, and if the backscatter reading device receives the same backscatter data from a passive UE (e.g., based on the passive UE ID) the backscatter reading device will not relay the backscatter data, thus avoiding duplication.

In some examples, a network entity may be designated as a primary backscatter reading device for backscatter data collection. A network entity may transmit a request to the radio frequency source device, and the radio frequency source may trigger transmission of backscatter data by one or more passive UEs. One or more backscatter reading device may receive the backscatter data multicast from the one or more passive UEs. The primary backscatter reading device may fail to receive some or all of the backscatter data (e.g., within a threshold amount of time), and may send a message to one or more other backscatter reading devices to request any missing passive UE backscatter data. The one or more additional backscatter reading device may respond to the request with any missing backscatter data. If the additional backscatter reading device do not receive a request from the primary reader with a period of time, the additional backscatter reading device may discard the collected data (e.g., the primary backscatter reading device received the data and additional relay is not necessary).

Aspects of the disclosure are initially described in the context of wireless communications systems. Aspects of the disclosure are further illustrated by and described with reference to wireless communications systems and process flow diagrams. Aspects of the disclosure are further illustrated by and described with reference to apparatus diagrams, system diagrams, and flowcharts that relate to duplication avoidance schemes in passive UE data delivery.

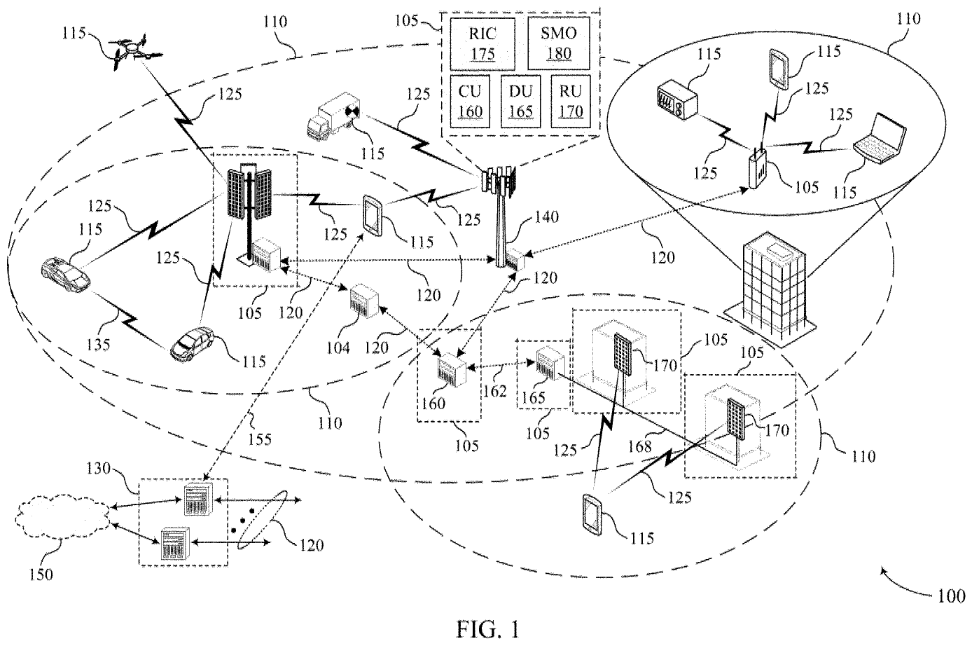

FIG. 1 illustrates an example of a wireless communications system 100 that supports duplication avoidance schemes in passive UE data delivery in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (VIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support duplication avoidance schemes in passive UE data delivery as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), ), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer,, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a network entity 105 without human intervention. In some examples, M2M communication or MTC may include communications from devices that integrate sensors or meters to measure or capture information and relay that information to a central server or application program that can make use of the information or present the information to humans interacting with the program or application. Some UEs 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat MI) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The described techniques provide for reducing duplication of backscatter data relay. In some examples, a backscatter reading device (e.g., a UE, or network entity), may be designated as a primary backscatter reading device for backscatter data collection and relaying. The primary backscatter reading device may collect the backscatter data from one or more additional backscatter reading devices and one or more passive UEs. The primary backscatter reading device may discard duplicated messages, and then relay the backscatter data to the network (e.g., via another device such as a network entity) without duplicates.

In some examples, a network entity may multicast feedback to backscatter reading devices to indicate which backscatter data messages have already been received. One or more backscatter reading devices may receive backscatter data from one or more passive UEs, and relay data to the network entity based on feedback messages from the network entity. The feedback message from the network entity may be multicast feedback to the backscatter reading devices including identifiers (IDs) of passive UEs of received data. If the backscatter reading device receives the same backscatter data from a passive UE (e.g., based on the passive UE ID) the backscatter reading device will not relay the backscatter data, thus avoiding duplication.

In some examples, a network entity may be designated as a primary backscatter reading device for backscatter data collection. A network entity may transmit a request to the radio frequency source device, and the radio frequency source may trigger transmission of backscatter data by one or more passive UEs. The primary backscatter reading device may fail to receive some or all of the backscatter data (e.g., within a threshold amount of time), and may send a message to one or more other backscatter reading devices to request any missing passive UE backscatter data. The one or more additional backscatter reading device may respond to the request with any missing backscatter data.

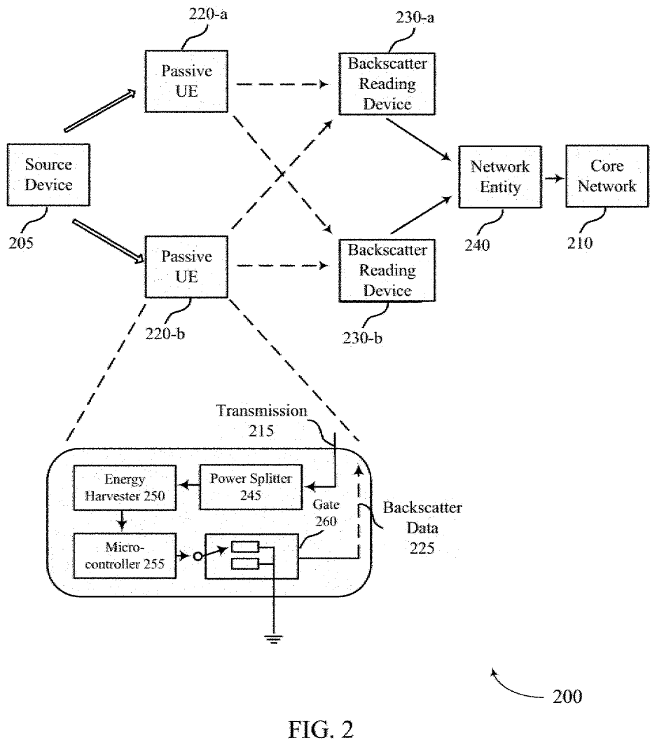

FIG. 2 illustrates an example of a wireless communications system 200 that supports duplication avoidance schemes in passive UE data delivery in accordance with one or more aspects of the present disclosure. Wireless communications system describes the relaying of data (e.g., transmissions 215) to a core network 210 via backscatter data 225 from a source device 205 using passive data delivery by the passive UEs 220 (e.g., passive UE 220-a, passive UE 225-b), as well as other devices.

The source device 205 may communicate with the core network 210 via relay. In some examples, the core network 210 may provide instructions (e.g., control signaling) to the source device 205. The source device 205 may send a transmission 215 (e.g., a signal, RF signal), which may be received by one or more passive UEs 220 (e.g., the passive UE 220-a, the passive UE 220-b). The passive UEs 220 may be examples of passive devices, which may receive the transmission 215, process the transmission 215, and send (e.g., relay) the transmission 215 as backscatter data 225. One or more backscatter reading devices 230 (e.g., backscatter reading device 230-a, backscatter reading device 230-b) may receive the backscatter data 225 and relay the backscatter data 225 via the data message 235 to the network entity 240. The network entity 240 may receive one or more data messages 235 and send a message to the core network 210.

A passive UE 220 (e.g., the passive UE 220-b) may perform energy harvesting and may generate backscatter data 225. The passive UE 220-b may receive the transmission 215 (e.g., from the source device 205, or reflected by another passive UE 220), and the pass the signal through a power splitter 245, energy harvester 250, and microcontroller 255. The microcontroller 255 may pass the signal to a discrete gate 260, or transistor logic, that outputs the backscatter data 225. In some examples described herein, the backscatter data 225 may include the ID of the passive UE 220-b. In some examples, the passive UE 220-b may modulate the transmission 215 for multicasting to other passive UEs 220, backscatter reading devices 230, or both.

FIG. 2 may illustrate an example of a passive IoT system. Passive IoT may be employed in NR or 5G advanced systems. Passive IoT systems may include devices, such as the passive UEs 220, or another passive device, that have no battery or limited battery. Instead, the passive UE 220 accumulates energy (e.g., via the terminal) from radio signaling (e.g., harvests energy from received RF signaling, such as the transmission 215). In some examples, the passive UE 220 may accumulate energy from solar energy, which may be a supplement to other accumulated energy. Passive UEs (or other passive devices) may be applicable in industrial settings where battery replacement is difficult, warehouses operating with low-cost features, among other examples.

Passive IoT systems may have specified capabilities or thresholds that are to be satisfied to support various applications or contexts. For example, a passive UE 220 in a passive IoT system may be expected to support a coverage capability (e.g., a communication distance within which the UE 220 is capable of performing communications). In a warehouse example, the communication distance may be 30 meters or more to construct a feasible network coverage of a 5000 m² warehouse. Additional capabilities may include passive UE 220 power consumption (e.g., less than 0.1 mW to support working without a battery), passive UE 220 cost (e.g., less than $0.02 to meet cost-sensitive applications), and positioning accuracy (e.g., a range of 3 m to 5 m in the horizonal and vertical directions with 90% accuracy), among other capabilities.

Passive IoT systems may support various use cases. For example, passive IoT systems may be applicable in industrial sensor use cases where replacing batteries is prohibitively difficult or undesirable, such as for safety monitoring or fault detection in smart factories, infrastructures, or environments. Another applicable context may be smart logistics or warehousing requiring devices with features such as extremely-low cost, small size, maintenance-free, durable, and a long lifespan, such as automated asset management in factories replacing radio-frequency identification (RFID) tags. Another example of an application for passive IoT systems may be a smart home network for household items managements, wearables, and environment monitoring, such as a wearable device for medical monitoring such that patients do not need to replace the battery themselves. Further, passive IoT systems may be advantageous for other contexts, such as for use cases corresponding to protocol enhancements to support operation on intermittently available energy harvested from the environment. Passive IoT systems are versatile and may be applied to many different applications and situations.

Passive devices may be implemented in IoT systems. A passive IoT device (e.g., which may be represented by a passive UE 220) may be a UE, tag, ambient backscatter device, or backscatter device, and may further reduce the cost of IoT devices and implement zero-power green communication. A passive UE 220 (e.g., backscatter device) may have simple hardware, as illustrated with reference to the passive UE 220-b. The passive UE 220 may have little to no battery, and may rely on energy harvesting to operate. The passive UE 220 may not have a radio wave transmission circuit, and may output data by reflecting the radio wave received (e.g., receiving the transmission 215 and outputting a reflection as backscatter data 225).

The passive UE 220 may receive a radio wave (e.g., the transmission 215) and reflect the radio wave (e.g., backscatter data 225). The radio frequency source (such as a gNB, network entity, or UE) may transmit an energy harvest wave to the passive UE 220 (e.g., the passive UE 220 may be an example of a passive-IoT device such as a tag or sensor). After the energy is accumulated sufficiently, the passive UE 220 may reflect the received radio wave (e.g., RF source wave, transmission 215) as the backscatter data 225. The reflection of the transmission 215 may follow a pattern (e.g., on/off) based on transmission information bits, such that the reflected backscatter data 225 transmits the information of the transmission 215. A backscatter reading device 230 (e.g., a reader such as a UE or a network entity) may detect the reflection pattern (e.g., the backscatter data 225), and thus receive the backscatter communication data. In some examples, the signaling (e.g., transmission 215) may be reflected by multiple passive UEs 220 to other passive UEs 220 as well as to one or more backscatter reading devices 230.

In some examples, one or more passive UEs 220 may multicast the backscatter data 225, and multiple backscatter reading devices 230 may receive and relay the same backscatter data (e.g., via the data message 235) to the network entity 240, resulting in duplicated data via the data messages 235. For example, if there are many passive UEs 220 and many backscatter reading devices 230, the backscatter data multicast from the passive UEs 220 may be more likely to be received by multiple backscatter reading devices 230. For instance, the passive UE 220-a may receive a transmission 215 and may multicast backscatter data 225, which may be received by the backscatter reading device 230-a and the backscatter reading device 230-b. Similarly, the passive UE 220-b may receive the transmission 215, and may multicast the backscatter data 225, which may be received by both the backscatter reading device 230-a and the backscatter reading device 230-b, resulting in duplication of the transmission 215 at both the backscatter ready device 230-a and the backscatter reading device 230-b. Relaying one or more duplicates of backscatter data 225 may result in unnecessary increases in signaling overhead, decreased throughput and inefficient use of system resources, increased power expenditures by the readers, increased network congestion and resource waste, and increased system latency.

There are many factors shown in FIG. 2, such as the transmission 215, passive UEs 220, and backscatter reading devices 230 that may result in duplication of data messages. The transmission 215 may be one data message, or multiple data messages, such that the backscatter data 225 may carry the same data or different data, and the data messages 235 may be the same or different. For example, the backscatter reading device 230-a may receive the backscatter data 225 from the passive UE 220-a and the passive UE 220-b, resulting in duplicate data. In another example, the source device 205 may transmit multiple transmissions 215, and the passive UE 220-a and the passive UE 220-b may receive and relay different data via the backscatter data 225. If the backscatter reading device 230-b receives different backscatter data from the passive UE 220-a and the passive UE 220-a, and the backscatter reading device only receives backscatter data from the passive UE 220-b, both backscatter reading devices 230 may relay duplicates of the backscatter data 225 from the passive UE 220-b to the network entity 240 via the data message 235, resulting in a duplicate message at the network entity 240.

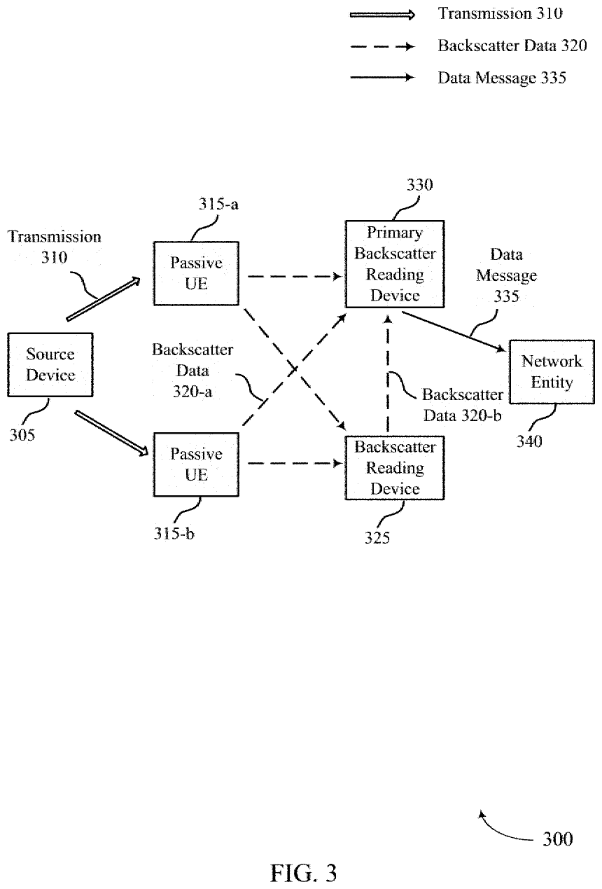

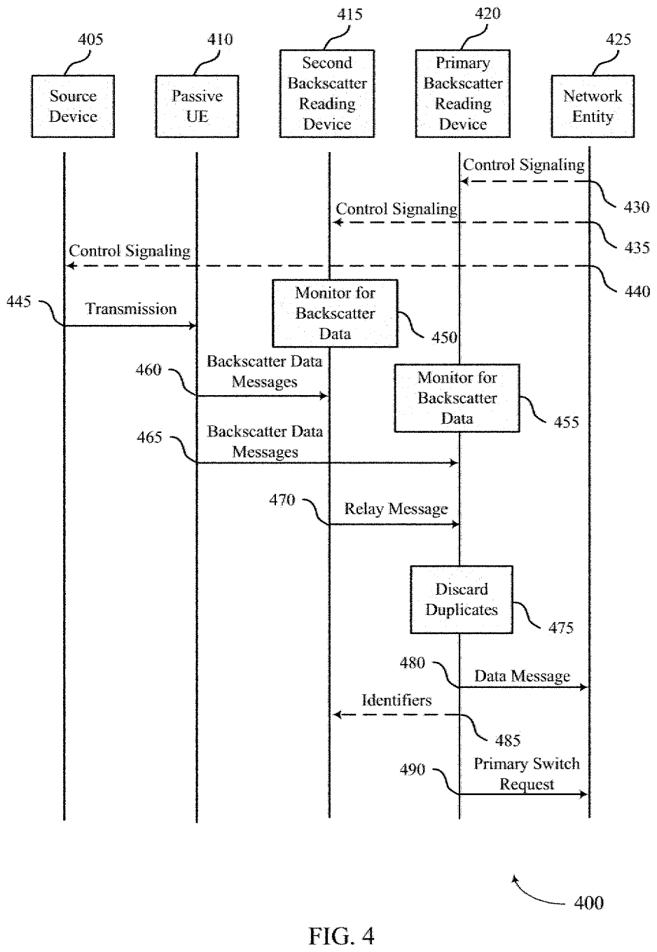

The techniques described herein may reduce or eliminate duplicated data messages received by the core network 210 or network entity 240. In some examples, explained in further detail with reference to FIGS. 3 and 4, a backscatter reading device 230 may be designated as a primary backscatter reading device for backscatter data 225 collection. The primary reading device may collect the backscatter data 225 from the backscatter reading devices 230 and passive UEs 220, discard duplicates, and transmit a data message 235 without duplicates to the network entity 240.

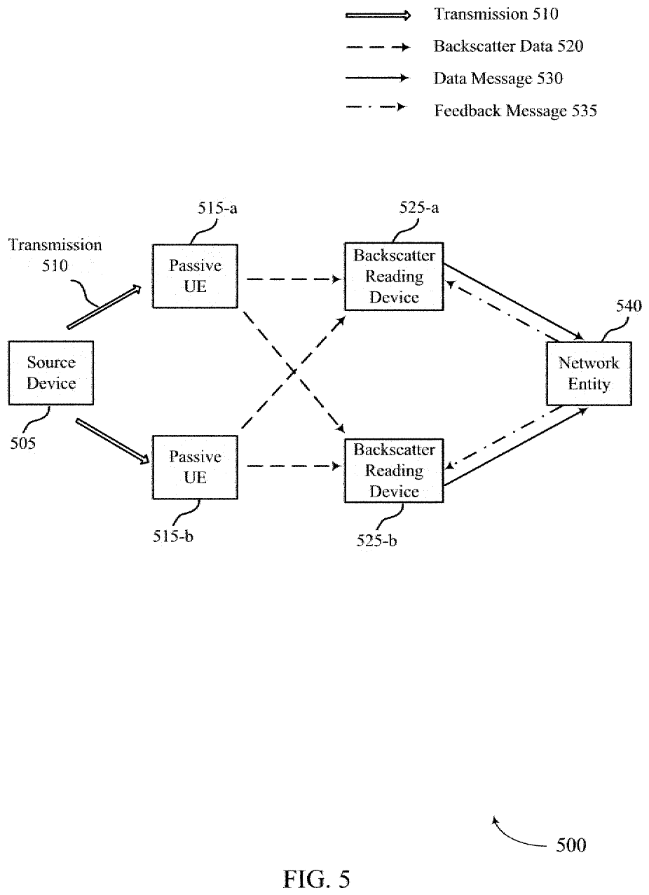

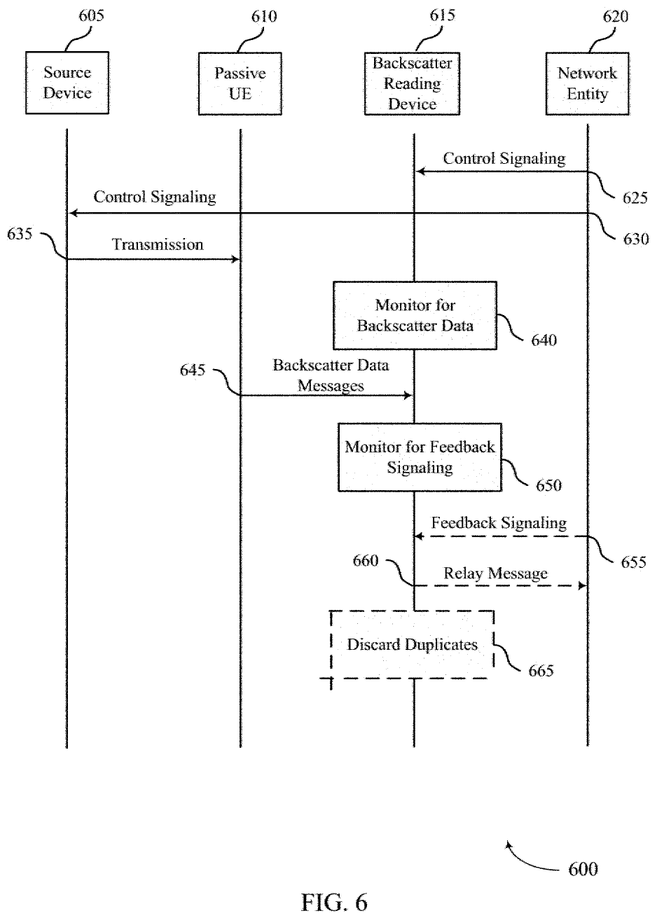

In some examples, as explained in further detail with reference to FIGS. 5 and 6, a network entity 240 may multicast feedback to one or more backscatter reading devices 230 indicating which backscatter data 225 has already been received. The feedback may include IDs of passive UE 220 corresponding to received data, such that the backscatter reading devices 230 may identify duplicate data received and refrain from transmitting duplicate data to the network entity 240.

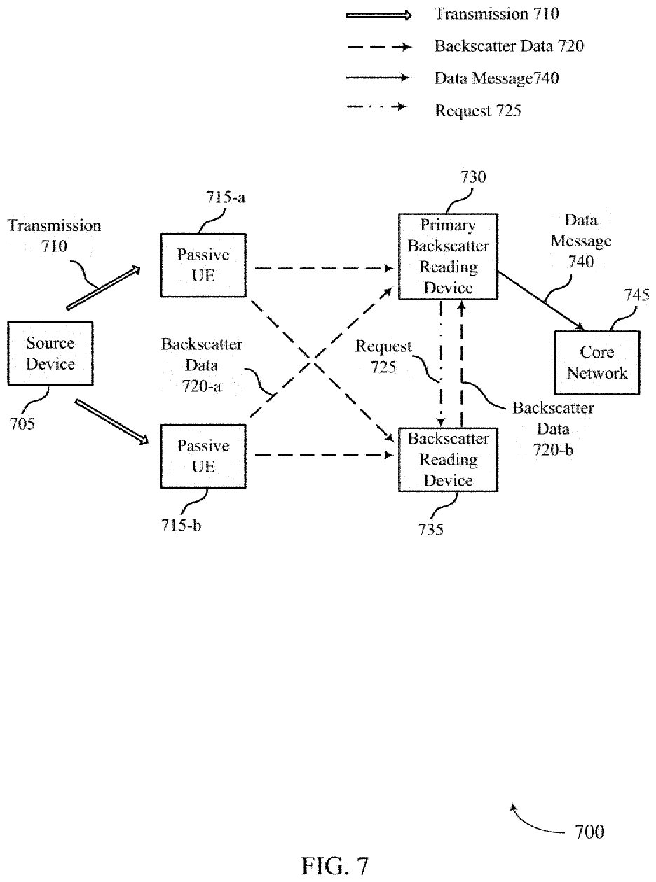

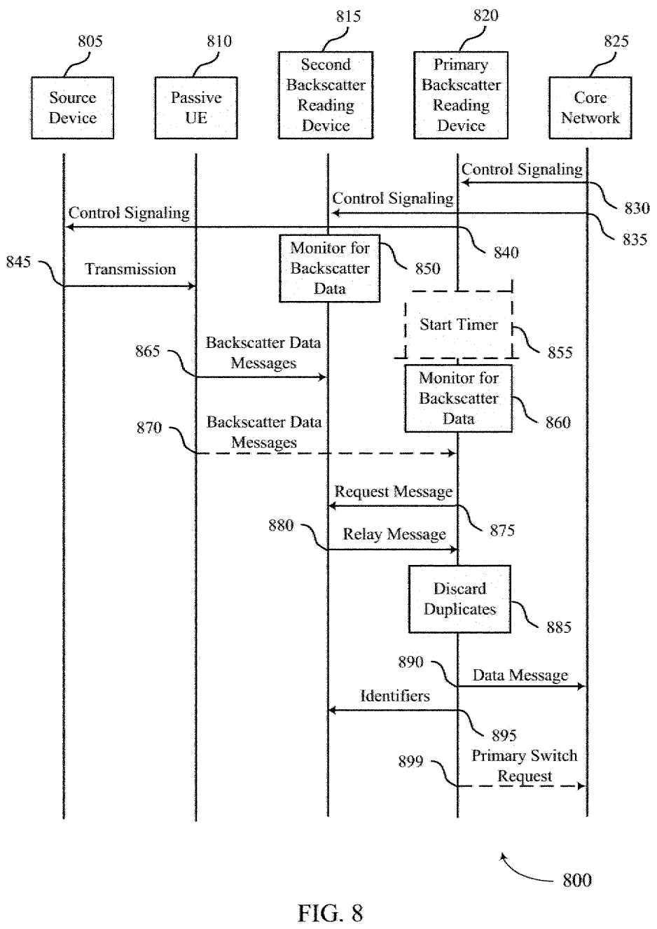

In some examples, as explained in further detail with reference to FIGS. 7 and 8, a backscatter reading device 230 (e.g., a network entity) may be designated as a primary reader for backscatter data 225 collection. The primary reading device may transmit a request to the source device 205, triggering the transmission 215. The primary backscatter reading device 230 may fail to receive some or all of the backscatter data (e.g., within a threshold amount of time), and may send a message to one or more other backscatter reading device 230 to request any missing passive UE data. The one or more additional backscatter reading devices 230 may respond with any missing backscatter data 225. If the additional backscatter reading device 230 do not receive a request from the primary backscatter reading device 230 with a period of time, the additional backscatter reading device 230 may discard the collected backscatter data 225.

FIG. 3 illustrates an example of a wireless communications system 300 that supports duplication avoidance schemes in passive UE data delivery in accordance with one or more aspects of the present disclosure. Wireless communications system 300 may be an example of a sidelink-assisted duplication avoidance scheme for passive IoT systems. A primary backscatter reading device 330 may receive backscatter data 320, discard duplicates, and forward the data via data message 335 to the network entity 340. In an example where the primary backscatter reading device 330 and the backscatter reading device 325 are UEs, the transmissions may be sidelink assisted.

A source device 305 may be an example of the source device 205, a transmission 310 may be an example of the transmission 215, a passive UE 315 may be an example of the passive UE 220, backscatter data 320-a may be an example of the backscatter data 225, a backscatter reading device 325 may be an example of the backscatter reading device 230, the primary backscatter reading device 330 may be an example of the backscatter reading device 230, the data message 335 may be an example of the data message 235, and the network entity 340 may be an example of the network entity 240, as described with reference to FIG. 3 and FIG. 2, respectively.

The source device 305 may send the transmission 310. The transmission 310 may be received by one or more passive UEs 315 (e.g., passive UE 315-a, passive UE 315-b) and may be reflected (e.g., multicast) as backscatter data 320-a. The backscatter reading device 325, the primary backscatter reading device 330, or both may receive the backscatter data 320-a. The backscatter reading device 325 may transmit backscatter data 320-b to the primary backscatter reading device 330, and may not transmit the backscatter data 320-b to the network entity 340. While not shown with reference to FIG. 3, the network entity 340 may relay data to a core network. In some examples, there may be multiple backscatter reading devices 325, which may transmit backscatter data 320-b to the primary backscatter reading device 330. The primary backscatter reading device 330 may discard duplicate backscatter data 320 (e.g., the backscatter data 320-a and the backscatter data 320-b and transmit the data message 335 to the network entity 340 without duplicates.

In some examples, the network entity 340 may indicate backscatter control information to the primary backscatter reading device 330, the backscatter reading device 325, or both. The backscatter control information, which may be referred to as control information, may be unicast or multicast from the network entity 340 (e.g., to the backscatter reading devices 325). In some examples, the network entity 340 may provide the control signaling to the source device 305, which may relay the control signaling to the backscatter reading devices 330 and 325 via the passive UEs 315. The backscatter reading device 325, the primary backscatter reading device 330, or both, may monitor and decode the backscatter data 320-a from one or more passive UEs 315, and may relay received backscatter data 320-a according to the backscatter control information. In some examples, the backscatter reading device 325 may monitor and decode the backscatter data 320-a, and may relay the received backscatter data 320-a via the backscatter data 320-b according to the backscatter control information. In some examples, the primary backscatter reading device 330 may monitor and decode the backscatter data 320-b, and may relay the received backscatter data 320-b according to the backscatter control information. In some examples, backscatter control information may be transmitted from the network entity 340 to the source device 305 for the source device 305, or backscatter control information may be transmitted from the network entity 340 to the source device 305 and included in the transmission 310 via the passive UEs 315.

In some examples, the network entity 340 may indicate control information to the primary backscatter reading device 330. The network entity 340 may indicate to the primary backscatter reading device 330 that the primary backscatter reading device 330 (e.g., itself) is the primary reader, via the control information. The primary backscatter reading device 330 may receive both the backscatter data 320-a and the backscatter data 320-b, and determine whether there are duplicates in the data. In some examples, the primary backscatter reading device 330 may receive the backscatter data 320-a from more than one passive UE 315, non-primary backscatter reading devices 325, or both, and may discard the duplicates. The primary backscatter reading device 330 may discard duplicated passive UE 315 backscatter data 320-a and backscatter reading device 325 backscatter data 320-b. The backscatter data 320-a and the backscatter data 320-b may be the same data or different data, and the backscatter data 320-a may include multiple data messages. For example, if the backscatter data 320-b is a duplicate of the backscatter data 320-a, then the primary backscatter reading device 330 may discard one of the duplicate messages, and relay the data message 335 (e.g., including only one copy of the backscatter data 320) to the network entity 340.

The network entity 340 may indicate to the primary backscatter reading device 330 to receive the backscatter data 320 from the other devices (e.g., passive UEs 315, backscatter reading device 325) via a particular radio access technology (RAT) or set of resources (e.g., via a PC5 link). In some examples, the primary backscatter reading device 330 may be configured (e.g., via the control signaling) to send the received backscatter data 320 (e.g., received from the backscatter reading device 325 via the PC5 link and from the passive UEs 315 in a forward link) to the network entity 340 (e.g., via a Uu link). In some examples, the network entity 340 may indicate (e.g., via control signaling) to the backscatter reading device 325 to send any received backscatter data 320 (e.g., the backscatter data 320-a) to the primary backscatter reading device 330 (e.g., via the backscatter data 320-b). The backscatter data 320-b may be an example of sidelink data (e.g., if the primary backscatter reading device 330 and the backscatter reading device 325 are both UEs).

In some examples, the backscatter data 320-a (e.g., passive UE data) may be bundled by the non-primary backscatter reading device 325. The backscatter data 320-b may be transmitted (e.g., via a physical sidelink shared channel (PSSCH)) from the backscatter reading device 325 (e.g., the non-primary reader) to the primary backscatter reading device 330 may include one or more backscatter data 320-a (e.g., one or more backscatter data 320-a from the passive UEs 315). The number of passive UEs 315 (e.g., corresponding to the number of backscatter data messages bundled) may be explicitly indicated in a physical sidelink control channel (PSCCH) or PSSCH.

In some examples, the backscatter data 320-b may include soft information. For example, the network entity 340 may indicate to the backscatter reading device 325 whether the soft information of the passive UE 315 backscatter data 320-a may be forwarded to the primary backscatter reading device 330. A soft information forwarding mode may be always allowed, not allowed, or dynamic (e.g., may be supported when triggered). A soft information dynamic mode may be allowed by primary backscatter reading device 330 request. The backscatter reading device 330 may combine the soft information together and transmit the soft information via the data message 335 for the network entity 340 to jointly decode the passive UE 315 backscatter data 320.

In some examples, the primary backscatter reading device 330 and a non-primary backscatter reading device 325 may perform a role switch (e.g., another reader may become the primary reader). For example, the primary backscatter reading device 330 may request a primary reader change. If the primary backscatter reading device 330 receives the backscatter data 320-a from a smaller number of passive UEs 315 than another backscatter reading device 325, the primary backscatter reading device 330 may transmit a request to the network entity 340 to change the primary reader. Such a switch may be triggered if the number of passive UEs 315 transmitting to another backscatter reading device 325 satisfies a threshold (e.g., if a first quantity of passive UEs 315 from which the primary backscatter reading device 330 receives backscatter data 320-a is a number (e.g., a threshold value) of times smaller than a second quantity of passive UEs 315 from which the backscatter reading device 325 receives backscatter data 320-a, or if a difference between the first quantity and the second quantity satisfies a threshold).

In some examples, the primary backscatter reading device may be switched due to link failure between the primary backscatter reading device 330 and the network entity 340. If the link between primary backscatter reading device 330 and network entity 340 fails, then the primary backscatter reading device 330 may refrain from monitoring and decoding the backscatter data 320-a from the passive UEs 315, and the network entity 340 may indicate a new primary backscatter reading device.

The primary backscatter reading device 330 may multicast (e.g., groupcast) IDs of passive UEs 315 (e.g., via physical sidelink feedback channel (PSFCH) or PSSCH) to one or more other backscatter reading devices 325. Multicasting the IDs of the passive UEs 315 may reduce sidelink duplication. The primary backscatter reading device 330 may multicast IDs of the passive UEs 315 from which the primary backscatter reading device 330 receives the backscatter data 320-a directly or from one of the backscatter reading devices 325 (e.g., non-primary reading device, receiving the backscatter data 320-a and forwarding the data as backscatter data 320-b). The primary backscatter reading device 330 may multicast IDs of the passive UEs 315 based on a periodic timer (e.g., periodically, upon expiration of the timer), or when the primary backscatter reading device 330 receives a threshold quantity of the backscatter data 320-a.

The source device 305 may forward backscatter control information from the network entity to the passive UE 315. The backscatter control information may indicate to the passive UE 315 to modulate the data of the transmission 310, or the received waveform, and reflect (multicast) the backscatter data 320-a to one or more readers (e.g., primary backscatter reading device 330, backscatter reading device 325).

FIG. 4 illustrates an example of a process flow diagram 400 that supports duplication avoidance schemes in passive UE data delivery in accordance with one or more aspects of the present disclosure. The process flow diagram 400 may illustrate an example of a sidelink-assisted duplication avoidance scheme for passive IoT systems as described. A primary backscatter reading device 420 may receive backscatter data 320, discard duplicates, and forward the data via a data message at 480 to the network entity 425. In an example where the primary backscatter reading device 420 and the second backscatter reading device 415 are UEs, the transmissions may be sidelink assisted.

FIG. 4 describes an example of a sidelink-assisted duplication avoidance scheme for passive IoT systems as described with reference to FIG. 3. The source device 405 may be an example of the source device 305, the passive UE 410 may be an example of the passive UEs 315, the second backscatter reading device 415 may be an example of the backscatter reading device 325, the primary backscatter reading device 420 may be an example of the primary backscatter reading device 330, and the network entity 425 may be an example of the network entity 340, as described with reference to FIG. 4 and FIG. 3, respectively. The second backscatter reading device 415 may be an example of additional backscatter reading devices, and the primary backscatter reading device 420 may be referred to as a first backscatter reading device 420. While one device may be illustrated with respect to FIG. 4, there may be more than one of any of the devices.

In the following description of the process flow diagram 400, the operations between the source device 405, passive UE 410, second backscatter reading device 415, primary backscatter reading device 420, and network entity 425 may be performed in different orders or at different times. Some operations may also be left out of the process flow diagram 400, or other operations may be added. Although the source device 405, passive UE 410, second backscatter reading device 415, primary backscatter reading device 420, and network entity 425 are shown performing the operations of the process flow diagram 400, some aspects of some operations may also be performed by one or more other wireless devices. Alternative examples of the following process flow diagram 400 may be implemented, where some steps are performed in a different order than described or are not performed at all. In some cases, steps may include additional features not mentioned below, or further steps may be added.

At 430, the first backscatter reading device 420 (e.g., a primary backscatter reading device as described in greater detail with reference to FIG. 3) may receive, from the network entity, control signaling indicating that the first backscatter reading device 420 is a primary backscatter reading device 420, where receiving the first backscatter data message (e.g., the relay message at 470) via the second backscatter reading device 415 is based on the control signaling indicating that the first backscatter reading device 420 is a primary backscatter reading device 420. In some examples, the first backscatter reading device 420 may receive data control signaling from the network entity 425 transmitted to the source device 405 and forwarded via the passive UE 410.

At 435, the second backscatter reading device 415 may receive, from the network entity, control signaling indicating that the second backscatter reading device 415 is a second backscatter reading device 415. In some examples, the second backscatter reading device 415 may receive data control signaling from the network entity 425 transmitted to the source device 405 and forwarded via the passive UE 410.

At 440, the source device 405 may receive control signaling. The control signaling may be for the source device indicating control signaling to be forwarded to the passive UE 410. In some examples, the control signaling forwarded to the passive UE 410 may be forwarded again to the second backscatter reading device 415 or primary backscatter reading device 420. In some examples, the control signaling transmitted to the source device 405 may schedule the transmission at 445.

At 445, the passive UE 410 may receive the transmission from the source device 405. In some examples, the passive UE 410 may also receive control signaling, which the passive UE 410 may forward to another device. The transmission may be RF signaling, which may charge the passive UE 410 or be transmitted as the one or more backscatter data messages at 460.

At 450, the second backscatter reading device (e.g., the second backscatter reading device 415), may monitor for backscatter data from one or more passive UEs 410.

At 455, the first backscatter reading device (e.g., the primary backscatter reading device 420), may monitor for backscatter data from multiple passive UEs 410 and one or more additional backscatter reading devices (e.g., the second backscatter reading device 415), or both. In some examples, the primary backscatter reading device 420 may monitor for backscatter data at the same time as the second backscatter reading device.

At 460, the passive UE 410 may transmit one or more backscatter data messages to the second backscatter reading device 415. The control signaling may indicate to the passive UE 410 to modulate data based on the received waveform at 445, and the control signaling may indicate to the passive UE 410 to reflect, or multicast, the backscatter data messages to one or more backscatter reading devices.

At 465, the first backscatter reading device 420 may receive, from one or more of the passive UEs 410 and based on the monitoring, multiple backscatter data messages, where at least one of the backscatter data messages includes a duplicate of the first backscatter data message (e.g., the relay message). For example, the backscatter data messages at 465 may include a duplicate of the data of the relay message at 470. In some examples, the first backscatter reading device 420 may receive one or more relay messages and one or more backscatter data messages from one or more additional reading devices (e.g., the second backscatter reading device 415) and passive UEs 410, where any of the messages may be duplicates.

At 470, the first backscatter reading device 420 may receive, based on the monitoring at 455, a first backscatter data message (e.g., a relay message) from a first passive UE 410 of the multiple of passive UEs via a second backscatter reading device 415 of the one or more additional backscatter reading devices. For example, the first backscatter reading device 420 may receive a relay message at 470 from the second backscatter reading device, where the relay message contains the one or more backscatter data messages 460 the second backscatter reading device 415 received from the passive UE 410. In some examples, there may be multiple passive UEs 410 or additional backscatter reading devices.

The relay message may include an indication of multiple backscatter data messages received by the second backscatter reading device 415, the indication further indicating a quantity of passive UEs 410 corresponding to the multiple backscatter data messages, where the multiple backscatter data messages include the first backscatter data message.

At 475, the first backscatter reading device 420 may discard duplicates. The first backscatter reading device 420 may discard the duplicate of the first backscatter data message at 470, where relaying the first backscatter data message to the network entity at 480 may be based on the discarding. In some examples, the first backscatter reading device 420 may be a first UE and the second backscatter reading device 415 may be a second UE. For example, the first backscatter reading device 420 may receive duplicate data from the backscatter data messages at 465 and the relay message 470, and discard the duplicates.

The first backscatter reading device 420 may combine one or more parameters associated with the first backscatter data message (e.g., the relay message at 470) and the duplicate of the first backscatter data message for joint decoding by the network entity 425, where relaying the first backscatter data message at 480 to the network entity 425 is based on the combining.

At 480, the first backscatter reading device 420 may relay the first backscatter data message via the data message to the network entity 425. The data message may be the first backscatter data message, additional backscatter data messages from passive UEs 410, the second backscatter reading device 415, or other reading devices, and may be without duplicates according to the discarding at 475.

At 485, the primary backscatter reading device 420 may transmit to multiple additional backscatter reading device including the second backscatter reading device, an indication of one or more IDs associated with respective passive UEs 410 of the quantity of passive UEs 410 corresponding to the multiple backscatter data messages.

At 490, the first backscatter reading device 420 may transmit, to the network entity 425, a request to switch the second backscatter reading device 415 to be a first backscatter reading device 420 responsive to the quantity of passive UEs 410 corresponding to the multiple backscatter data messages received by the second backscatter reading device 415 being greater than a second quantity of backscatter data messages received by the first backscatter reading device 420.

FIG. 5 illustrates an example of a wireless communications system 500 that supports duplication avoidance schemes in passive UE data delivery in accordance with one or more aspects of the present disclosure. The wireless communications system 500 may describe a multicast-feedback-assisted duplication avoidance scheme. A network entity 540 may multicast feedback via a feedback message 535, which may result in duplication avoidance.

A source device 505 may be an example of the source device 205, a transmission 510 may be an example of the transmission 215, a passive UE 515 may be an example of the passive UE 220, backscatter data 520 may be an example of the backscatter data 225, a backscatter reading device 525 may be an example of the backscatter reading device 230, a data message 530 may be an example of the data message 235, and the network entity 540 may be an example of the network entity 240, as described with reference to FIG. 5 and FIG. 2, respectively.

FIG. 5 may illustrate an example of a multicast-feedback-assisted duplication avoidance scheme for passive IoT systems. The network entity may receive relayed backscatter data 520, and may multicast the feedback message 535 for backscatter reading devices 525 to avoid duplicated backscatter data 520 relaying (e.g., relaying via the data message 530). The source device 505 may send the transmission 510. The transmission 510 may be received by one or more passive UEs 515 (e.g., passive UE 515-a, passive UE 515-b) and may be reflected (e.g., multicast) as backscatter data 520. The backscatter reading devices 525 (e.g., backscatter reading device 525-a and backscatter reading device 525-b) may receive the backscatter data 520 from one or more passive UEs 515. The one or more backscatter reading devices 525 may transmit backscatter data 520 to the network entity 540 via the data message 530. In some examples, the backscatter reading devices 525 may be UEs. The network entity 540 may transmit (e.g., multicast) the feedback message 535 to one or more backscatter reading devices 525. The feedback message 535 may include IDs of one or more passive UEs 515 (e.g., indicating passive UEs 515 from which the network entity 540 has already received backscatter data 520), such that the backscatter reading devices 525 may avoid transmitting duplicate data via the data message 530.

In some examples, the backscatter reading device 525 may receive backscatter control information. For example, the network entity 540 may indicate backscatter control information to the one or more backscatter reading devices 525. The backscatter control information may include an indication for the backscatter reading devices 525 to monitor and decode the backscatter data 520 from the one or more passive UEs 515. The backscatter control information may be unicast or multicast from the network entity 540 (e.g., directly to the backscatter reading devices 525), or may be conveyed to the source device 505 and then to the backscatter reading devices 525 via the passive UEs 515.

The backscatter reading devices 525 may monitor for a feedback message 535 multicast from the network entity 540. The feedback message 535 may include the ACK information of the passive UE data as well as its associated passive UE ID. The backscatter reading devices 525 may refrain from transmitting backscatter data that has an associated passive UE ID indicated in the feedback message 535. For example, the passive UE 515-b may multicast backscatter data 520, which may be received by the backscatter reading device 525-a and the backscatter reading device 525-b. The backscatter reading device 525-a may forward the received backscatter data via a data message 530, to the network entity 540. The network entity 540 may multicast a feedback message 535 to the backscatter reading device 525-a and the backscatter reading device 525-b, which may include an indication of a passive UE ID for the passive UE 515-b (e.g., as indicated in the backscatter data 520 and the data message 530). The backscatter reading device 525-b may receive the feedback message 535, and may determine not to transmit a duplicate of the backscatter data 520 received from the passive UE 515-b (e.g., because the feedback message 535 indicates that the network entity 540 has already received the backscatter data 520 from the passive UE 515-b). By using the passive UE ID information from the feedback message 535 to refrain from transmitting the same data from the same passive UE via the data message 530, data duplication may be avoided.

The backscatter reading devices 525 may discard backscatter data 520 from the passive UEs 515 based on receiving the multicast feedback message 535. The passive UE ID indicated in the feedback message 535 indicates successful reception of the data message 530 at the network entity 540.

The passive UE 515 may receive backscatter control information from the source device 505, which was forwarded from the network entity 540. The backscatter control information may instruct the passive UE 515 to modulate the received waveform of transmission 510 and reflect, or multicast, the modulated waveform as backscatter data 520 to one or more backscatter reading devices 525.

FIG. 6 illustrates an example of a process flow diagram 600 that supports duplication avoidance schemes in passive UE data delivery in accordance with one or more aspects of the present disclosure. The process flow diagram 600 may describe a multicast-feedback-assisted duplication avoidance scheme, also described with reference to FIG. 5. A network entity 620 may multicast feedback via a feedback message, or feedback signaling, which may result in duplication avoidance.

The source device 605 may be an example of the source device 505, the passive UE 610 may be an example of the passive UEs 515, the backscatter reading device 615 may be an example of the backscatter reading device 525, and the network entity 620 may be an example of the network entity 540, as described with reference to FIG. 6 and FIG. 5, respectively. The backscatter reading device 615 may be an example of additional backscatter reading devices. While one device may be illustrated with respect to FIG. 6, there may be more than one of any of the devices.

In the following description of the process flow diagram 600, the operations between the source device 605, passive UE 610, second backscatter reading device 615, and network entity 620 may be performed in different orders or at different times. Some operations may also be left out of the process flow diagram 600, or other operations may be added. Although the source device 605, passive UE 610, backscatter reading device 615, and network entity 620 are shown performing the operations of the process flow diagram 600, some aspects of some operations may also be performed by one or more other wireless devices. Alternative examples of the following process flow diagram 600 may be implemented, where some steps are performed in a different order than described or are not performed at all. In some cases, steps may include additional features not mentioned below, or further steps may be added.

At 625, a first backscatter reading device 615, or the backscatter reading device 615, may receive control signaling indicating that the first backscatter reading device 615 is to monitor for backscatter data from the one or more passive UEs 610. In some examples, the first backscatter reading device 615 may be a UE.

In some examples, the control signaling may include multicast control signaling for multiple backscatter reading devices including the first backscatter reading device. In some other examples, the control signaling may include unicast control signaling for the first backscatter reading device 615.

At 630, the source device 405 may receive control signaling from the network entity 620. The control signaling may be for the source device 605 device indicating control signaling to be forwarded to the passive UE 610. In some examples, the control signaling forwarded to the passive UE 610 may be forwarded again to the first backscatter reading device 615. In some examples, the control signaling transmitted to the source device 405 may schedule the transmission at 445.

At 635, the passive UE 610 may receive the transmission from the source device 605. The transmission may be RF signaling, which may charge the passive UE 610 or be transmitted as the one or more backscatter data messages at 460. In some examples, the transmission may include control signaling forwarded by the source device 605 from the network entity 620.

At 640, the first backscatter reading device 615 may monitor for backscatter data based on the control signaling.

At 645, the first backscatter reading device 615 may receive multiple backscatter data messages from one or more passive UEs 610 based on receiving the control signaling.

At 650, the first backscatter reading device 615 may monitor for feedback signaling, from a network entity 620, corresponding to one or more of the multiple backscatter data messages.

At 655, the first backscatter reading device 615 may receive, based on the monitoring, a first feedback message from the network entity 620 indicating that the network entity 620 has successfully received a second backscatter data message of the multiple backscatter data messages. The first feedback message may include a device ID corresponding to a first passive UE 610 of the multiple passive UEs 610, and the backscatter reading device 615 may discard the backscatter data message based on receiving the device ID.

The first backscatter reading device 615 may receive, based on the monitoring, multiple feedback messages, each feedback message corresponding to a device ID of a respective passive UE 610 of the multiple passive UEs. The first backscatter reading device 615 may determine that none of the received feedback messages indicate a device ID associated with the first backscatter data message, and may transmit (e.g., relay)the first backscatter data message to the network entity 620 based on the determining.

At 660, the first backscatter reading device 615 may forward at least a first backscatter data message via the relay message to the network entity 620 based on the monitoring (e.g., if a feedback signaling received at 655 does not indicate that the first backscatter data message has been received by the network entity 620).

At 665, the first backscatter reading device 615 may discard the second backscatter data message of the multiple backscatter data messages based on the first feedback message. For example, if the second backscatter data message is a duplicate of the first feedback message, the first backscatter reading device 615 may discard the second backscatter data message. The discarding may be based on receiving the device ID. For example, the first backscatter reading device 615 may use the device ID to determine if the first and second backscatter data messages are duplicates or are not duplicates.

FIG. 7 illustrates an example of a wireless communications system 700 that supports duplication avoidance schemes in passive UE data delivery in accordance with one or more aspects of the present disclosure. Wireless communications system 700 may be an example of request-based backscatter data forwarding. A primary backscatter reading device 730, such as network entity, may transmit a request 725 to the backscatter reading device 735 before forwarding the data to the core network via the data message 740.

A source device 705 may be an example of the source device 205, a transmission 710 may be an example of the transmission 215, a passive UE 715 may be an example of the passive UE 220, backscatter data 720 may be an example of the backscatter data 225, the backscatter reading device 735 may be an example of the backscatter reading device 230, the primary backscatter reading device 730 may be an example of the backscatter reading device 230, the data message 740 may be an example of the data message 235, and the core network 745 may be an example of the core network 210, as described with reference to FIG. 7 and FIG. 2, respectively.

In some examples, the primary backscatter reading device 730 and backscatter reading device 735 may be network entities. As described with reference to FIG. 7, the primary backscatter reading device 730 and the backscatter reading device 735 may be described as network entities. However, in some examples, one or both devices may be examples of another device, such as a UE.

FIG. 7 may illustrate an example of a request-based backscatter data forwarding scheme for passive IoT systems and data duplication avoidance. The primary backscatter reading device 730 may transmit control signaling to the source device 705, which may be forwarded to the passive UEs 715, to transmit the backscatter data 720-a. The source device 705 may send the transmission 710. One or more passive UEs 715 (e.g., the passive UE 715-a and the passive UE 715-b) may receive the transmission 710, and reflect (e.g., multicast) the transmission 710 as backscatter data 720-a. The primary backscatter reading device 730, the backscatter reading device 735, or both, may monitor for or receive at least a portion of the backscatter data 720-a. In some examples, the primary backscatter reading device 730 may fail to receive some or a portion of the backscatter data 720-a. The primary backscatter reading device 730 may transmit a request 725 to the backscatter reading device 735 requesting any missing backscatter data 720-a (e.g., upon expiration of a timer). The backscatter reading device 735 may transmit the missing backscatter data 720-a via the backscatter data 720-b to the primary backscatter reading device 730 based on the request 725. The primary backscatter reading device 730 may forward the backscatter data 720, without duplicates, to the core network 745 via the data message 740.

In some examples, the primary backscatter reading device 735 may transmit the request 725 based on a first timer. A first timer may be defined for reception of backscatter data 720-a. For example, the primary backscatter reading device 730 may initiate the first timer starts when the primary backscatter reading device 730 transmits control signaling to the source device 705 (e.g., triggering transmission 710), which is forwarded to the passive UEs 715, to transmit the backscatter data 720-a. If the first timer expires and the primary backscatter reading device 730 has not received the backscatter data 720-a from one or more passive UEs 715, the primary backscatter reading device 730 may transmit the request 725 (e.g., requesting that the backscatter reading device 735 forward the backscatter data 720-b for which the primary backscatter reading device 730 has been monitoring). The primary backscatter reading device 730 may transmit the request 725 to the backscatter reading device 735 via an interface (e.g., Xn interface). The request 725 may be a message including the one or more passive UE IDs corresponding to the missing backscatter data 720-a.

For example, the primary backscatter reading device 730 may not receive the backscatter data 720-a from the passive UE 715-b before the expiration of the first timer. At the expiration of the first timer, the primary backscatter reading device 730 may transmit the request 725 to the backscatter reading device 735 including the ID of the passive UE 715-b. The backscatter reading device 735 may then the backscatter data 720-b (e.g., which may be a copy of or may otherwise relay the backscatter data 720-a received by the backscatter reading device 735 from the passive UE 715-b) to the primary backscatter reading device 730.

A second timer may be defined for data reception of the backscatter data 720-a at the backscatter reading device 735. The backscatter reading device 735 may initiate the second timer when the backscatter reading device 735 (e.g., the non-primary backscatter reading device) receives backscatter data 720-a. If the second timer expires, and the backscatter reading device 735 has not received a request 725 from the primary backscatter reading device 730, then the backscatter reading device 735 may discard the received backscatter data 720-a.

In some examples, the primary backscatter reading device 730 and a non-primary backscatter reading device 325 may perform a role switch (e.g., another reader may become the primary reader). For example, the primary backscatter reading device 730 may request a role switch from the core network 745 if the primary backscatter reading device 730 receives backscatter data 720-a from a smaller number of passive UEs 715 than another reader (e.g., the backscatter reading device 735). Such a switch may be triggered if the number of passive UEs 715 transmitting to the primary backscatter reading device 730 satisfies a threshold (e.g., if a first quantity of passive UEs 715 from which the primary backscatter reading device 330 receives backscatter data 720-a is a number (e.g., a threshold value) of times smaller than a second quantity of passive UEs 715 from which the backscatter reading device 730 receives backscatter data 720-a, or if a difference between the first quantity and the second quantity satisfies a threshold).

FIG. 8 illustrates an example of a process flow diagram 800 that supports duplication avoidance schemes in passive UE data delivery in accordance with one or more aspects of the present disclosure. Process flow diagram 800 may describe an example of request-based backscatter data forwarding, a scheme for duplication avoidance of passive UE data.

FIG. 8 describes an example of a request-based backscatter data forwarding scheme for passive IoT systems and data duplication avoidance as described with reference to FIG. 7. The source device 805 may be an example of a source device 705, the passive UE 810 may be an example of the passive UEs 715, a second backscatter reading device 815 may be an example of the backscatter reading device 735, a primary backscatter reading device 820 may be an example of the primary backscatter reading device 730, and the core network 825 may be an example of the core network 745, as described with reference to FIG. 8 and FIG. 7, respectively. The second backscatter reading device 815 may be an example of additional backscatter reading devices, and the primary backscatter reading device 820 may be referred to as a first backscatter reading device 820. In some examples, the second backscatter reading device 815 and the primary backscatter reading device 820 may be examples of network entities. While one device may be illustrated with respect to FIG. 8, there may be more than one of any of the devices.

In the following description of the process flow diagram 800, the operations between the source device 805, passive UE 810, second backscatter reading device 815, primary backscatter reading device 820, and core network 825 may be performed in different orders or at different times. Some operations may also be left out of the process flow diagram 800, or other operations may be added. Although the source device 805, passive UE 810, second backscatter reading device 815, primary backscatter reading device 820, and core network 825 are shown performing the operations of the process flow diagram 800, some aspects of some operations may also be performed by one or more other wireless devices. Alternative examples of the following process flow diagram 800 may be implemented, where some steps are performed in a different order than described or are not performed at all. In some cases, steps may include additional features not mentioned below, or further steps may be added.

At 830, the first backscatter reading device 820 (e.g., a primary backscatter reading device as described with reference to FIG. 7) may receive, from the core network 825, control signaling indicating that the first backscatter reading device 820 is a first backscatter reading device 820. Receiving the first backscatter data message (e.g., the relay message at 880) via the second backscatter reading device 815 may be based on the control signaling indicating that the first backscatter reading device 820 is a first backscatter reading device 820.

At 835, the second backscatter reading device 815 may receive, from the core network 825, control signaling indicating that the second backscatter reading device 815 is a second backscatter reading device 815.

At 840, the first backscatter reading device 820 may transmit, to at least the first passive UE 810 via a radio frequency source device 805, control signaling including an instruction to transmit the first backscatter data message. In some examples, the source device 405 may receive control signaling for the source device 805 to forward to the passive UE 810. In some examples, the control signaling transmitted to the source device 805 may schedule the transmission at 845. That is, the control signaling may be for the source device 805, the passive UE 810, or both.

At 845, the source device 805 may transmit a message based on the control signaling. The passive UE 810 may receive the transmission from the source device 805. In some examples, the passive UE 810 may also receive control signaling, which the passive UE 810 may forward to another device. The transmission may be RF signaling, which may charge the passive UE 810 or be transmitted as the one or more backscatter data messages at 865 and 870.

At 850, the second backscatter reading device 815 may monitor for backscatter data from one or more passive UEs 810.

At 855, the first backscatter reading device 820 (e.g., or primary backscatter reading device 820), may start a timer (e.g., a first timer) upon transmitting the control signaling at 840.

At 860, the first backscatter reading device may monitor for backscatter data from one or more passive UEs 810 and one or more additional backscatter reading devices (e.g., the second backscatter reading device 815), or both. The first backscatter reading device 820 may monitor for backscatter data at the same time as the second backscatter reading device 815. The primary backscatter reading device 820 may monitor for the first backscatter data message based on transmitting the control signaling.

At 865, the passive UE 810 may transmit one or more backscatter data messages to the second backscatter reading device 815 based on the control signaling.

At 870, the first backscatter reading device 820 may receive, from one or more of the passive UEs 810 and based on the monitoring, multiple backscatter data messages. In some examples, there may be duplicates of messages from multiple passive UEs 810.

At 875, the first backscatter reading device 820 may transmit, to the second backscatter reading device 815 and based on the monitoring, a request for the first backscatter data message. Transmitting the request for the first backscatter data message may be based on expiration of the timer. For example, at the expiration of the timer, the first backscatter reading device 820 may transmit a request for any missing backscatter data. In some examples, the first backscatter reading device 820 may be a first network entity, and the second backscatter reading device 815 may be a second network entity.

At 880, the first backscatter reading device 820 may receive, based on the monitoring, a first backscatter data message from a first passive UE 810 of the multiple of passive UEs 810 via a second backscatter reading device 815 of the one or more additional backscatter reading devices. The first backscatter reading device 820 may receive the relay message from the second backscatter reading device 815 based on transmitting the request. For example, the primary backscatter reading device may receive a relay message from the second backscatter reading device 815, where the relay message contains the one or more backscatter data messages at 865 the second backscatter reading device 815 received from the passive UE 810. In some examples, there may be multiple passive UEs 810 or additional reading devices.

The relay message may include an indication of multiple backscatter data messages received by the second backscatter reading device 815, the indication further indicating a quantity of passive UEs 810 corresponding to the multiple backscatter data messages.

In some examples, the second backscatter reading device 815 may start a second timer at 865 upon receiving one or more backscatter data messages. If the second backscatter reading device 815 does not receive a request message from the first backscatter reading device 820 by the expiration of the timer, the second backscatter reading device 815 may discard any backscatter data.

At 885, the first backscatter reading device 420 may discard duplicates. The first backscatter reading device 420 may discard any duplicates received in the backscatter data messages at 870.

At 890, the first backscatter reading device 820 may relay the first backscatter data message via the data message to the core network 825. The data message may be the first backscatter data message, additional backscatter data messages from passive UEs 810, the second backscatter reading device 815, or other reading devices, and may be without duplicates according to the discarding at 885.

At 895, the first backscatter reading device 820 may transmit to multiple additional backscatter reading devices including the second backscatter reading device 815, an indication of one or more IDs associated with respective passive UEs 810 of the quantity of passive UEs 810 corresponding to the multiple backscatter data messages.

At 899, the first backscatter reading device 820 may transmit, to the core network 825, a request to switch the second backscatter reading device 815 to be a first backscatter reading device 820 responsive to the quantity of passive UEs 810 corresponding to the multiple backscatter data messages received by the second backscatter reading device 815 being greater than a second quantity of backscatter data messages received by the first backscatter reading device 820.

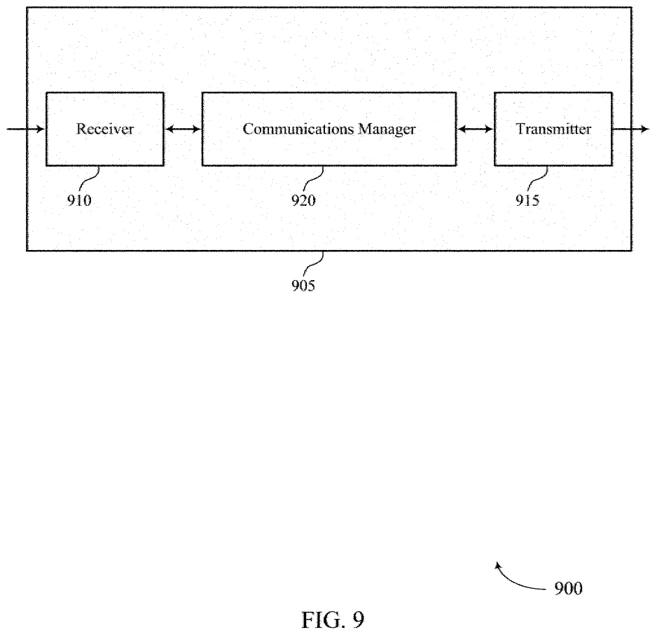

FIG. 9 illustrates a block diagram 900 of a device 905 that supports duplication avoidance schemes in passive UE data delivery in accordance with one or more aspects of the present disclosure. The device 905 may be an example of aspects of a wireless device as described herein. The device 905 may include a receiver 910, a transmitter 915, and a communications manager 920. The device 905 may also include a processor. Each of these components may be in communication with one another (e.g., via one or more buses). In some examples, the device 905 may be a UE, as described with respect to FIGS. 2-6, or may be a network entity, as described with respect to FIGS. 7 and 8. In some examples, the device 905 may be a wireless device or any other device.

The receiver 910 may provide a means for receiving information such as packets, user data, control information, or any combination thereof associated with various information channels (e.g., control channels, data channels, information channels related to duplication avoidance schemes in passive UE data delivery). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to duplication avoidance schemes in passive UE data delivery). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of duplication avoidance schemes in passive UE data delivery as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software) executed by a processor. If implemented in code executed by a processor, the functions of the communications manager 920, the receiver 910, the transmitter 915, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a first backscatter reading device in accordance with examples as disclosed herein. For example, the communications manager 920 may be configured as or otherwise support a means for monitoring for backscatter data from a set of multiple passive user equipments (UEs), one or more additional backscatter reading devices, or both. The communications manager 920 may be configured as or otherwise support a means for receiving, based on the monitoring, a first backscatter data message from a first passive UE of the set of multiple passive UEs via a second backscatter reading device of the one or more additional backscatter reading devices. The communications manager 920 may be configured as or otherwise support a means for relaying the first backscatter data message to a network entity.

Additionally, or alternatively, the communications manager 920 may support wireless communications at a first backscatter reading device in accordance with examples as disclosed herein. For example, the communications manager 920 may be configured as or otherwise support a means for receiving control signaling indicating that the first backscatter reading device is to monitor for backscatter data from a set of multiple passive user equipments (UEs). The communications manager 920 may be configured as or otherwise support a means for receiving a set of multiple backscatter data messages from one or more passive UEs based on receiving the control signaling. The communications manager 920 may be configured as or otherwise support a means for monitoring for feedback signaling, from a network entity, corresponding to one or more of the set of multiple backscatter data messages. The communications manager 920 may be configured as or otherwise support a means for forwarding at least a first backscatter data message of the set of multiple backscatter data messages to the network entity based on the monitoring.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for duplication avoidance schemes in passive UE data delivery, which may result in reduced processing, reduced power consumption, more efficient utilization of communication resources, or a combination thereof, among other advantages.

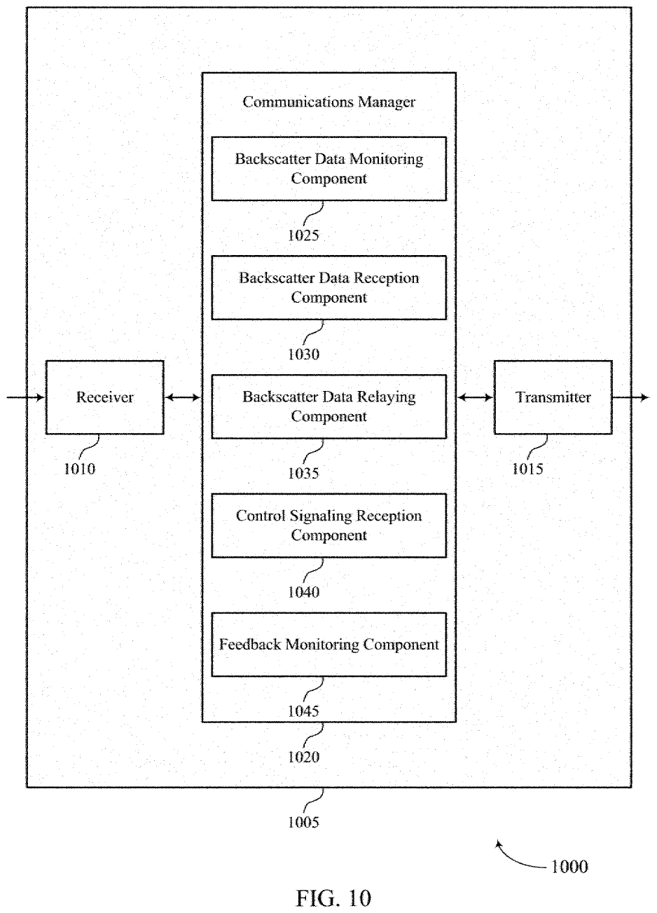

FIG. 10 illustrates a block diagram 1000 of a device 1005 that supports duplication avoidance schemes in passive UE data delivery in accordance with one or more aspects of the present disclosure. The device 1005 may be an example of aspects of a device 905 or a UE 115 as described herein. The device 1005 may include a receiver 1010, a transmitter 1015, and a communications manager 1020. The device 1005 may also include a processor. Each of these components may be in communication with one another (e.g., via one or more buses). In some examples, the device 1005 may be a UE, as described with respect to FIGS. 2-6, or may be a network entity, as described with respect to FIGS. 7 and 8. In some examples, the device 1005 may be a wireless device or another device.

The receiver 1010 may provide a means for receiving information such as packets, user data, control information, or any combination thereof associated with various information channels (e.g., control channels, data channels, information channels related to duplication avoidance schemes in passive UE data delivery). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to duplication avoidance schemes in passive UE data delivery). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of duplication avoidance schemes in passive UE data delivery as described herein. For example, the communications manager 1020 may include a backscatter data monitoring component 1025, a backscatter data reception component 1030, a backscatter data relaying component 1035, a control signaling reception component 1040, a feedback monitoring component 1045, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first backscatter reading device in accordance with examples as disclosed herein. The backscatter data monitoring component 1025 may be configured as or otherwise support a means for monitoring for backscatter data from a set of multiple passive user equipments (UEs), one or more additional backscatter reading devices, or both. The backscatter data reception component 1030 may be configured as or otherwise support a means for receiving, based on the monitoring, a first backscatter data message from a first passive UE of the set of multiple passive UEs via a second backscatter reading device of the one or more additional backscatter reading devices. The backscatter data relaying component 1035 may be configured as or otherwise support a means for relaying the first backscatter data message to a network entity.

Additionally, or alternatively, the communications manager 1020 may support wireless communications at a first backscatter reading device in accordance with examples as disclosed herein. The control signaling reception component 1040 may be configured as or otherwise support a means for receiving control signaling indicating that the first backscatter reading device is to monitor for backscatter data from a set of multiple passive user equipments (UEs). The backscatter data reception component 1030 may be configured as or otherwise support a means for receiving a set of multiple backscatter data messages from one or more passive UEs based on receiving the control signaling. The feedback monitoring component 1045 may be configured as or otherwise support a means for monitoring for feedback signaling, from a network entity, corresponding to one or more of the set of multiple backscatter data messages. The backscatter data relaying component 1035 may be configured as or otherwise support a means for forwarding at least a first backscatter data message of the set of multiple backscatter data messages to the network entity based on the monitoring.

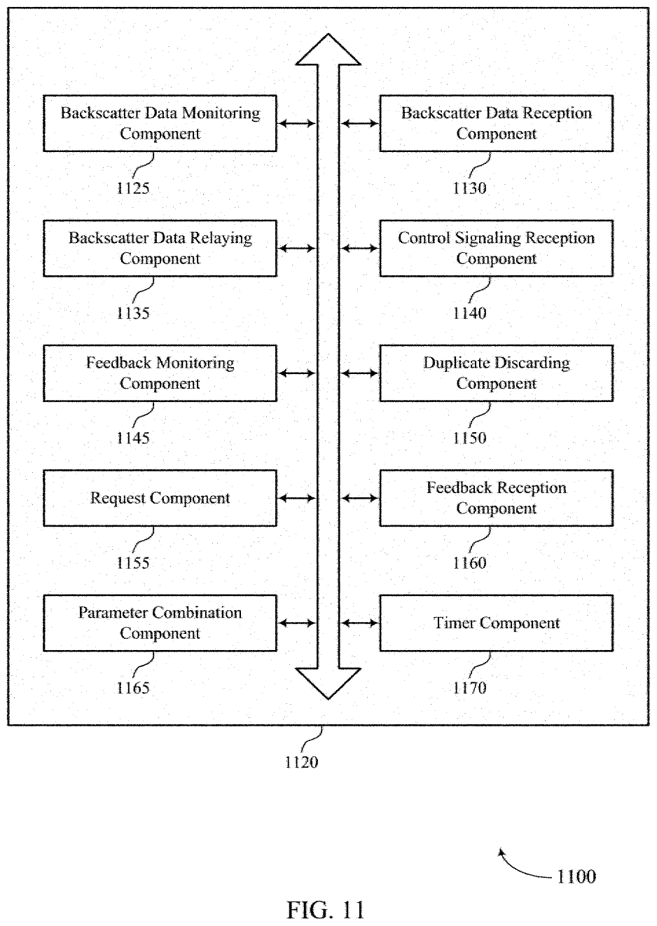

FIG. 11 illustrates a block diagram 1100 of a communications manager 1120 that supports duplication avoidance schemes in passive UE data delivery in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of duplication avoidance schemes in passive UE data delivery as described herein. For example, the communications manager 1120 may include a backscatter data monitoring component 1125, a backscatter data reception component 1130, a backscatter data relaying component 1135, a control signaling reception component 1140, a feedback monitoring component 1145, a duplicate discarding component 1150, a request component 1155, a feedback reception component 1160, a parameter combination component 1165, a timer component 1170, or any combination thereof. Each of these components may communicate, directly or indirectly, with one another (e.g., via one or more buses). In some examples, the device including the communications manager 1120 may be a UE, as described with respect to FIGS. 2-6, or may be a network entity, as described with respect to FIGS. 7 and 8.

The communications manager 1120 may support wireless communications at a first backscatter reading device in accordance with examples as disclosed herein. The backscatter data monitoring component 1125 may be configured as or otherwise support a means for monitoring for backscatter data from a set of multiple passive user equipments (UEs), one or more additional backscatter reading devices, or both. The backscatter data reception component 1130 may be configured as or otherwise support a means for receiving, based on the monitoring, a first backscatter data message from a first passive UE of the set of multiple passive UEs via a second backscatter reading device of the one or more additional backscatter reading devices. The backscatter data relaying component 1135 may be configured as or otherwise support a means for relaying the first backscatter data message to a network entity.

In some examples, the backscatter data reception component 1130 may be configured as or otherwise support a means for receiving, from one or more of the set of multiple passive UEs or the one or more additional backscatter reading devices based on the monitoring, a set of multiple backscatter data messages, where at least one of the set of multiple backscatter data messages includes a duplicate of the first backscatter data message. In some examples, the duplicate discarding component 1150 may be configured as or otherwise support a means for discarding the duplicate of the first backscatter data message, where relaying the first backscatter data message to the network entity is based on the discarding, where the first backscatter reading device includes a first UE and the second backscatter reading device includes a second UE.

In some examples, the parameter combination component 1165 may be configured as or otherwise support a means for combining one or more parameters associated with the first backscatter data message and the duplicate of the first backscatter data message for joint decoding by the first backscatter reading device, where relaying the first backscatter data message to the network entity is based on the combining.

In some examples, the control signaling reception component 1140 may be configured as or otherwise support a means for receiving, from the network entity, control signaling indicating that the first backscatter reading device is a primary backscatter reading device, where receiving the first backscatter data message via the second backscatter reading device is based on the control signaling indicating that the first backscatter reading device is a primary backscatter reading device.

In some examples, to support receiving the first backscatter data message from the first passive UE via the second backscatter reading device, the backscatter data reception component 1130 may be configured as or otherwise support a means for receiving, from the second backscatter reading device, an indication of a set of multiple backscatter data messages received by the second backscatter reading device, the indication further indicating a quantity of passive UEs corresponding to the set of multiple backscatter data messages, where the set of multiple backscatter data messages includes the first backscatter data message.

In some examples, the backscatter data reception component 1130 may be configured as or otherwise support a means for transmitting, to the network entity, a request to switch the second backscatter reading device to be a primary backscatter reading device responsive to the quantity of passive UEs corresponding to the set of multiple backscatter data messages received by the second backscatter reading device being greater than a second quantity of backscatter data messages received by the first backscatter reading device.

In some examples, the backscatter data reception component 1130 may be configured as or otherwise support a means for transmitting, to a set of multiple additional backscatter reading device including the second backscatter reading device, an indication of one or more identifiers associated with respective passive UEs of the quantity of passive UEs corresponding to the set of multiple backscatter data messages.

In some examples, the request component 1155 may be configured as or otherwise support a means for transmitting, to the second backscatter reading device based on the monitoring, a request for the first backscatter data message, where receiving the first backscatter data message from the second backscatter reading device is based on transmitting the request.

In some examples, the request component 1155 may be configured as or otherwise support a means for transmitting, to at least the first passive UE via a radio frequency source device, control signaling including an instruction to transmit the first backscatter data message. In some examples, the timer component 1170 may be configured as or otherwise support a means for initiating a timer upon transmitting the control signaling. In some examples, the backscatter data monitoring component 1125 may be configured as or otherwise support a means for monitoring for the first backscatter data message based on transmitting the control signaling, where transmitting the request for the first backscatter data message is based at least in part upon expiration of the timer. In some examples, the first backscatter reading device includes a first network entity, and the second backscatter reading device includes a second network entity.

Additionally, or alternatively, the communications manager 1120 may support wireless communications at a first backscatter reading device in accordance with examples as disclosed herein. The control signaling reception component 1140 may be configured as or otherwise support a means for receiving control signaling indicating that the first backscatter reading device is to monitor for backscatter data from a set of multiple passive user equipments (UEs). In some examples, the backscatter data reception component 1130 may be configured as or otherwise support a means for receiving a set of multiple backscatter data messages from one or more passive UEs based on receiving the control signaling. The feedback monitoring component 1145 may be configured as or otherwise support a means for monitoring for feedback signaling, from a network entity, corresponding to one or more of the set of multiple backscatter data messages. In some examples, the backscatter data relaying component 1135 may be configured as or otherwise support a means for forwarding at least a first backscatter data message of the set of multiple backscatter data messages to the network entity based on the monitoring.

In some examples, the feedback reception component 1160 may be configured as or otherwise support a means for receiving, based on the monitoring, a first feedback message from the network entity indicating that the network entity has successfully received a second backscatter data message of the set of multiple backscatter data messages. In some examples, the duplicate discarding component 1150 may be configured as or otherwise support a means for discarding the second backscatter data message of the set of multiple backscatter data messages based on the first feedback message.

In some examples, the first feedback message includes a device identifier corresponding to a first passive UE of the set of multiple passive UEs. In some examples, the discarding is based on receiving the device identifier.

In some examples, the feedback reception component 1160 may be configured as or otherwise support a means for receiving, based on the monitoring, a set of multiple feedback messages, each feedback message corresponding to a device identifier of a respective passive UE of the set of multiple passive UEs. In some examples, the feedback reception component 1160 may be configured as or otherwise support a means for determining that none of the received feedback messages indicate a device identifier associated with the first backscatter data message, where transmitting the first backscatter data message is based on the determining.

In some examples, the first backscatter reading device includes a UE. In some examples, the control signaling includes multicast control signaling for a set of multiple backscatter reading devices including the first backscatter reading device. In some examples, the control signaling includes unicast control signaling for the first backscatter reading device.

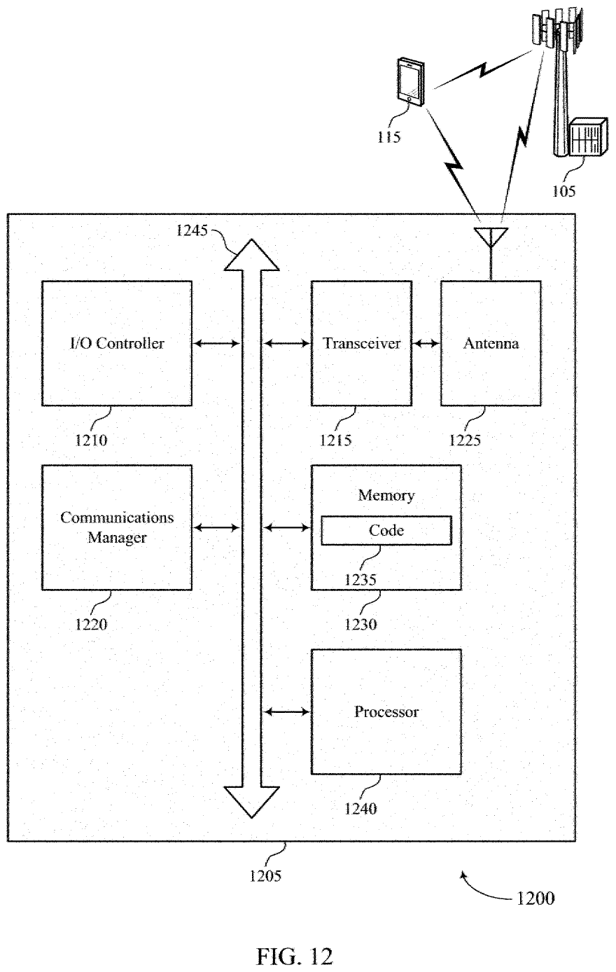

FIG. 12 illustrates a diagram of a system 1200 including a device 1205 that supports duplication avoidance schemes in passive UE data delivery in accordance with one or more aspects of the present disclosure. The device 1205 may be an example of or include the components of a device 905, a device 1005, or a wireless device as described herein. The device 1205 may include components for bi-directional voice and data communications including components for transmitting and receiving communications, such as a communications manager 1220, an I/O controller 1210, a transceiver 1215, an antenna 1225, a memory 1230, code 1235, and a processor 1240. These components may be in electronic communication or otherwise coupled (e.g., operatively, communicatively, functionally, electronically, electrically) via one or more buses (e.g., a bus 1245). In some examples, the device 1205 may be a UE, as described with respect to FIGS. 2-6, or may be a network entity, as described with respect to FIGS. 7 and 8. In some examples, the device 1205 may be a wireless device or any type of device.

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting duplication avoidance schemes in passive UE data delivery). For example, the device 1205 or a component of the device 1205 may include a processor 1240 and memory 1230 coupled with or to the processor 1240, the processor 1240 and memory 1230 configured to perform various functions described herein.

The communications manager 1220 may support wireless communications at a first backscatter reading device in accordance with examples as disclosed herein. For example, the communications manager 1220 may be configured as or otherwise support a means for monitoring for backscatter data from a set of multiple passive user equipments (UEs), one or more additional backscatter reading devices, or both. The communications manager 1220 may be configured as or otherwise support a means for receiving, based on the monitoring, a first backscatter data message from a first passive UE of the set of multiple passive UEs via a second backscatter reading device of the one or more additional backscatter reading devices. The communications manager 1220 may be configured as or otherwise support a means for relaying the first backscatter data message to a network entity.

Additionally, or alternatively, the communications manager 1220 may support wireless communications at a first backscatter reading device in accordance with examples as disclosed herein. For example, the communications manager 1220 may be configured as or otherwise support a means for receiving control signaling indicating that the first backscatter reading device is to monitor for backscatter data from a set of multiple passive user equipments (UEs). The communications manager 1220 may be configured as or otherwise support a means for receiving a set of multiple backscatter data messages from one or more passive UEs based on receiving the control signaling. The communications manager 1220 may be configured as or otherwise support a means for monitoring for feedback signaling, from a network entity, corresponding to one or more of the set of multiple backscatter data messages. The communications manager 1220 may be configured as or otherwise support a means for forwarding at least a first backscatter data message of the set of multiple backscatter data messages to the network entity based on the monitoring.

By including or configuring the communications manager 1220 in accordance with examples as described herein, the device 1205 may support techniques for duplication avoidance schemes in passive UE data delivery, which may result in improved communication reliability, reduced latency, improved user experience related to reduced processing, reduced power consumption, more efficient utilization of communication resources, improved coordination between devices, longer battery life, improved utilization of processing capability, or a combination thereof, among other advantages.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 (e.g., directly, indirectly, after pre-processing or compiling, without pre-processing or compiling) to cause the device 1205 to perform various aspects of duplication avoidance schemes in passive UE data delivery as described herein, or the processor 1240 and the memory 1230 may be otherwise configured to perform or support such operations.

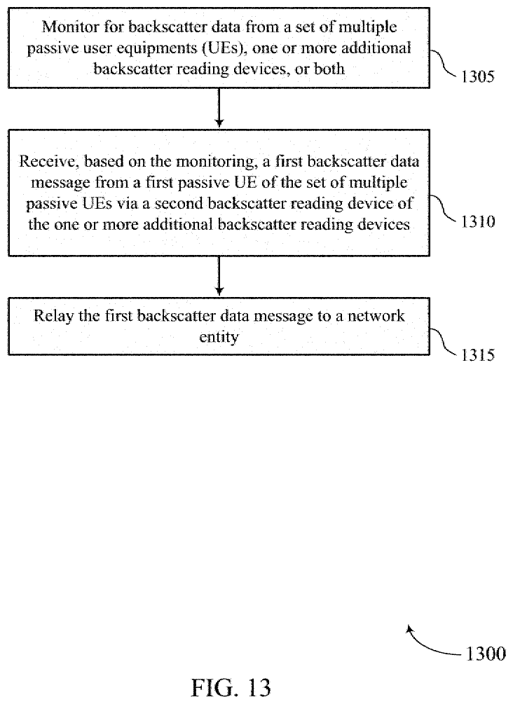

FIG. 13 illustrates a flowchart showing a method 1300 that supports duplication avoidance schemes in passive UE data delivery in accordance with one or more aspects of the present disclosure. The operations of the method 1300 may be implemented by a wireless device or its components as described herein. For example, the operations of the method 1300 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware. In some examples, the wireless device may be a UE, as described with respect to FIGS. 2-6, or may be a network entity, as described with respect to FIGS. 7 and 8, or another device.

At 1305, the method may include monitoring for backscatter data from a set of multiple passive user equipments (UEs), one or more additional backscatter reading devices, or both. The operations of 1305 may be performed in accordance with examples as disclosed herein. In some examples, aspects of the operations of 1305 may be performed by a backscatter data monitoring component 1125 as described with reference to FIG. 11.

At 1310, the method may include receiving, based on the monitoring, a first backscatter data message from a first passive UE of the set of multiple passive UEs via a second backscatter reading device of the one or more additional backscatter reading devices. The operations of 1310 may be performed in accordance with examples as disclosed herein. In some examples, aspects of the operations of 1310 may be performed by a backscatter data reception component 1130 as described with reference to FIG. 11.

At 1315, the method may include relaying the first backscatter data message to a network entity. The operations of 1315 may be performed in accordance with examples as disclosed herein. In some examples, aspects of the operations of 1315 may be performed by a backscatter data relaying component 1135 as described with reference to FIG. 11.

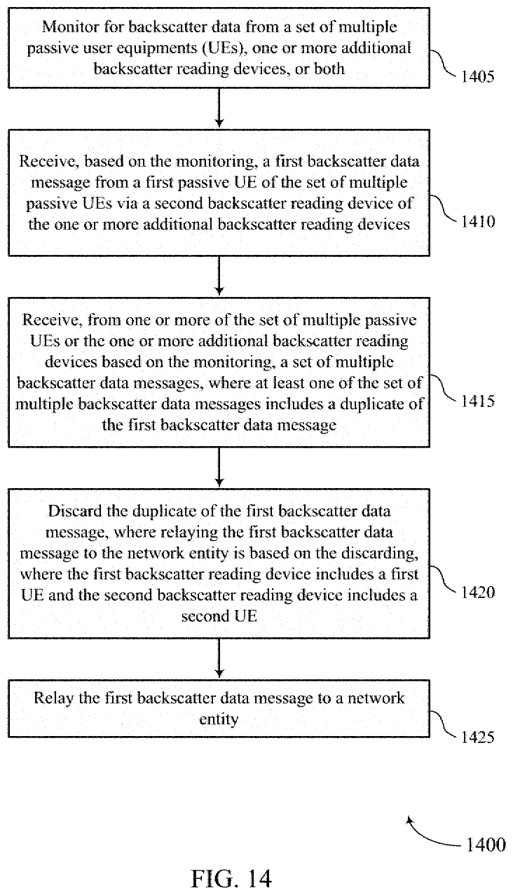

FIG. 14 illustrates a flowchart showing a method 1400 that supports duplication avoidance schemes in passive UE data delivery in accordance with one or more aspects of the present disclosure. The operations of the method 1400 may be implemented by a wireless device or its components as described herein. For example, the operations of the method 1400 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware. In some examples, the wireless device may be a UE, as described with respect to FIGS. 2-6, or may be a network entity, as described with respect to FIGS. 7 and 8, or another device.

At 1405, the method may include monitoring for backscatter data from a set of multiple passive user equipments (UEs), one or more additional backscatter reading devices, or both. The operations of 1405 may be performed in accordance with examples as disclosed herein. In some examples, aspects of the operations of 1405 may be performed by a backscatter data monitoring component 1125 as described with reference to FIG. 11.

At 1410, the method may include receiving, based on the monitoring, a first backscatter data message from a first passive UE of the set of multiple passive UEs via a second backscatter reading device of the one or more additional backscatter reading devices. The operations of 1410 may be performed in accordance with examples as disclosed herein. In some examples, aspects of the operations of 1410 may be performed by a backscatter data reception component 1130 as described with reference to FIG. 11.

At 1415, the method may include receiving, from one or more of the set of multiple passive UEs or the one or more additional backscatter reading devices based on the monitoring, a set of multiple backscatter data messages, where at least one of the set of multiple backscatter data messages includes a duplicate of the first backscatter data message. The operations of 1415 may be performed in accordance with examples as disclosed herein. In some examples, aspects of the operations of 1415 may be performed by a backscatter data reception component 1130 as described with reference to FIG. 11.

At 1420, the method may include discarding the duplicate of the first backscatter data message. In some examples, the first backscatter reading device may be a first UE and the second backscatter reading device may be a second UE. The operations of 1420 may be performed in accordance with examples as disclosed herein. In some examples, aspects of the operations of 1420 may be performed by a duplicate discarding component 1150 as described with reference to FIG. 11.

At 1425, the method may include relaying the first backscatter data message to a network entity based at least in part on the discarding. The operations of 1425 may be performed in accordance with examples as disclosed herein. In some examples, aspects of the operations of 1425 may be performed by a backscatter data relaying component 1135 as described with reference to FIG. 11.

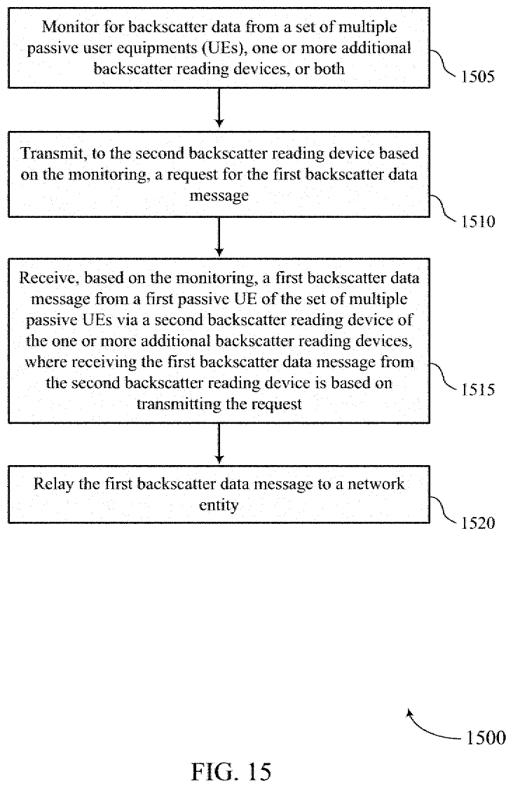

FIG. 15 illustrates a flowchart showing a method 1500 that supports duplication avoidance schemes in passive UE data delivery in accordance with one or more aspects of the present disclosure. The operations of the method 1500 may be implemented by a wireless device or its components as described herein. For example, the operations of the method 1500 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware. In some examples, the wireless device may be a UE, as described with respect to FIGS. 2-6, or may be a network entity, as described with respect to FIGS. 7 and 8, or another device.

At 1505, the method may include monitoring for backscatter data from a set of multiple passive user equipments (UEs), one or more additional backscatter reading devices, or both. The operations of 1505 may be performed in accordance with examples as disclosed herein. In some examples, aspects of the operations of 1505 may be performed by a backscatter data monitoring component 1125 as described with reference to FIG. 11.

At 1510, the method may include transmitting, to the second backscatter reading device based on the monitoring, a request for the first backscatter data message. The operations of 1510 may be performed in accordance with examples as disclosed herein. In some examples, aspects of the operations of 1510 may be performed by a request component 1155 as described with reference to FIG. 11.

At 1515, the method may include receiving, based on the monitoring, a first backscatter data message from a first passive UE of the set of multiple passive UEs via a second backscatter reading device of the one or more additional backscatter reading devices, where receiving the first backscatter data message from the second backscatter reading device is based on transmitting the request. The operations of 1515 may be performed in accordance with examples as disclosed herein. In some examples, aspects of the operations of 1515 may be performed by a backscatter data reception component 1130 as described with reference to FIG. 11.

At 1520, the method may include relaying the first backscatter data message to a network entity. The operations of 1520 may be performed in accordance with examples as disclosed herein. In some examples, aspects of the operations of 1520 may be performed by a backscatter data relaying component 1135 as described with reference to FIG. 11.

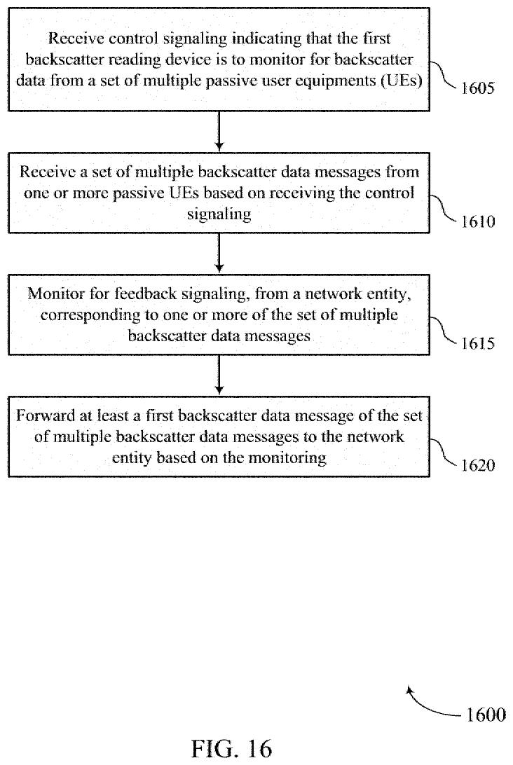

FIG. 16 illustrates a flowchart showing a method 1600 that supports duplication avoidance schemes in passive UE data delivery in accordance with one or more aspects of the present disclosure. The operations of the method 1600 may be implemented by a wireless device or its components as described herein. For example, the operations of the method 1600 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware. In some examples, the wireless device may be a UE, as described with respect to FIGS. 2-6, or may be a network entity, as described with respect to FIGS. 7 and 8, or another device.

At 1605, the method may include receiving control signaling indicating that the first backscatter reading device is to monitor for backscatter data from a set of multiple passive user equipments (UEs). The operations of 1605 may be performed in accordance with examples as disclosed herein. In some examples, aspects of the operations of 1605 may be performed by a control signaling reception component 1140 as described with reference to FIG. 11.

At 1610, the method may include receiving a set of multiple backscatter data messages from one or more passive UEs based on receiving the control signaling. The operations of 1610 may be performed in accordance with examples as disclosed herein. In some examples, aspects of the operations of 1610 may be performed by a backscatter data reception component 1130 as described with reference to FIG. 11.

At 1615, the method may include monitoring for feedback signaling, from a network entity, corresponding to one or more of the set of multiple backscatter data messages. The operations of 1615 may be performed in accordance with examples as disclosed herein. In some examples, aspects of the operations of 1615 may be performed by a feedback monitoring component 1145 as described with reference to FIG. 11.

At 1620, the method may include forwarding at least a first backscatter data message of the set of multiple backscatter data messages to the network entity based on the monitoring. The operations of 1620 may be performed in accordance with examples as disclosed herein. In some examples, aspects of the operations of 1620 may be performed by a backscatter data relaying component 1135 as described with reference to FIG. 11.

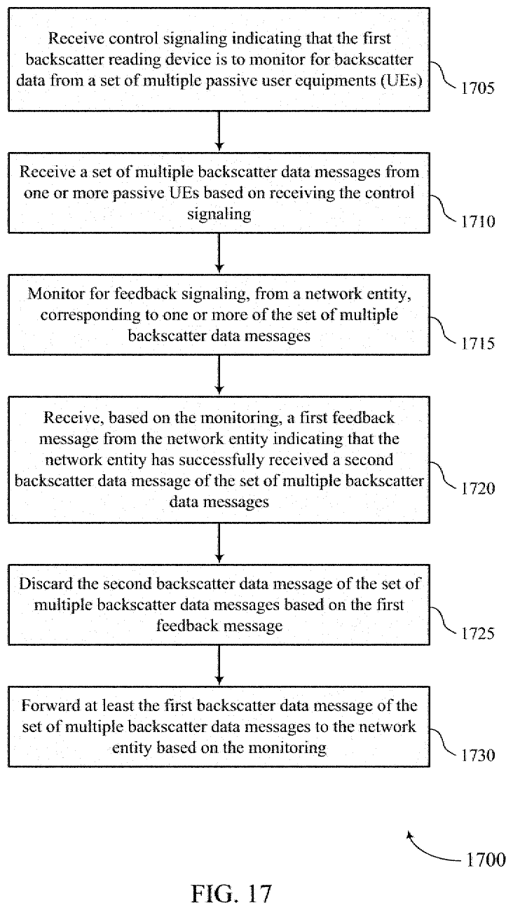

FIG. 17 illustrates a flowchart showing a method 1700 that supports duplication avoidance schemes in passive UE data delivery in accordance with one or more aspects of the present disclosure. The operations of the method 1700 may be implemented by a wireless device or its components as described herein. For example, the operations of the method 1700 may be performed by a wireless device as described with reference to FIGS. 1 through 12. In some examples, a wireless device may execute a set of instructions to control the functional elements of the wireless device to perform the described functions. Additionally, or alternatively, the wireless device may perform aspects of the described functions using special-purpose hardware. In some examples, the wireless device may be a UE, as described with respect to FIGS. 2-6, or may be a network entity, as described with respect to FIGS. 7 and 8, or another device.

At 1705, the method may include receiving control signaling indicating that the first backscatter reading device is to monitor for backscatter data from a set of multiple passive user equipments (UEs). The operations of 1705 may be performed in accordance with examples as disclosed herein. In some examples, aspects of the operations of 1705 may be performed by a control signaling reception component 1140 as described with reference to FIG. 11.

At 1710, the method may include receiving a set of multiple backscatter data messages from one or more passive UEs based on receiving the control signaling. The operations of 1710 may be performed in accordance with examples as disclosed herein. In some examples, aspects of the operations of 1710 may be performed by a backscatter data reception component 1130 as described with reference to FIG. 11.

At 1715, the method may include monitoring for feedback signaling, from a network entity, corresponding to one or more of the set of multiple backscatter data messages. The operations of 1715 may be performed in accordance with examples as disclosed herein. In some examples, aspects of the operations of 1715 may be performed by a feedback monitoring component 1145 as described with reference to FIG. 11.

At 1720, the method may include receiving, based on the monitoring, a first feedback message from the network entity indicating that the network entity has successfully received a second backscatter data message of the set of multiple backscatter data messages. The operations of 1720 may be performed in accordance with examples as disclosed herein. In some examples, aspects of the operations of 1720 may be performed by a feedback reception component 1160 as described with reference to FIG. 11.

At 1725, the method may include discarding the second backscatter data message of the set of multiple backscatter data messages based on the first feedback message. The operations of 1725 may be performed in accordance with examples as disclosed herein. In some examples, aspects of the operations of 1725 may be performed by a duplicate discarding component 1150 as described with reference to FIG. 11.

At 1730, the method may include forwarding at least the first backscatter data message of the set of multiple backscatter data messages to the network entity based on the monitoring. The operations of 1730 may be performed in accordance with examples as disclosed herein. In some examples, aspects of the operations of 1730 may be performed by a backscatter data relaying component 1135 as described with reference to FIG. 11.

The following provides an overview of aspects of the present disclosure:

Aspect 1: A method for wireless communications at a first backscatter reading device, comprising: monitoring for backscatter data from a plurality of passive user equipments (UEs), one or more additional backscatter reading devices, or both; receiving, based at least in part on the monitoring, a first backscatter data message from a first passive UE of the plurality of passive UEs via a second backscatter reading device of the one or more additional backscatter reading devices; and relaying the first backscatter data message to a network entity.

Aspect 2: The method of aspect 1, further comprising: receiving, from one or more of the plurality of passive UEs or the one or more additional backscatter reading devices based at least in part on the monitoring, a plurality of backscatter data messages, wherein at least one of the plurality of backscatter data messages comprises a duplicate of the first backscatter data message; and discarding the duplicate of the first backscatter data message, wherein relaying the first backscatter data message to the network entity is based at least in part on the discarding, wherein the first backscatter reading device comprises a first UE and the second backscatter reading device comprises a second UE.

Aspect 3: The method of aspect 2, further comprising: combining one or more parameters associated with the first backscatter data message and the duplicate of the first backscatter data message for joint decoding by the first backscatter reading device, wherein relaying the first backscatter data message to the network entity is based at least in part on the combining.

Aspect 4: The method of any of aspects 1 through 3, further comprising: receiving, from the network entity, control signaling indicating that the first backscatter reading device is a primary backscatter reading device, wherein receiving the first backscatter data message via the second backscatter reading device is based at least in part on the control signaling indicating that the first backscatter reading device is a primary backscatter reading device.

Aspect 5: The method of any of aspects 1 through 4, wherein receiving the first backscatter data message from the first passive UE via the second backscatter reading device comprises: receiving, from the second backscatter reading device, an indication of a plurality of backscatter data messages received by the second backscatter reading device, the indication further indicating a quantity of passive UEs corresponding to the plurality of backscatter data messages, wherein the plurality of backscatter data messages comprises the first backscatter data message.

Aspect 6: The method of aspect 5, further comprising: transmitting, to the network entity, a request to switch the second backscatter reading device to be a primary backscatter reading device responsive to the quantity of passive UEs corresponding to the plurality of backscatter data messages received by the second backscatter reading device being greater than a second quantity of backscatter data messages received by the first backscatter reading device.

Aspect 7: The method of any of aspects 5 through 6, further comprising: transmitting, to a plurality of additional backscatter reading device comprising the second backscatter reading device, an indication of one or more identifiers associated with respective passive UEs of the quantity of passive UEs corresponding to the plurality of backscatter data messages.

Aspect 8: The method of any of aspects 1 through 7, further comprising: transmitting, to the second backscatter reading device based at least in part on the monitoring, a request for the first backscatter data message, wherein receiving the first backscatter data message from the second backscatter reading device is based at least in part on transmitting the request.

Aspect 9: The method of aspect 8, further comprising: transmitting, to at least the first passive UE via a radio frequency source device, control signaling comprising an instruction to transmit the first backscatter data message; initiating a timer upon transmitting the control signaling; and monitoring for the first backscatter data message based at least in part on transmitting the control signaling, wherein transmitting the request for the first backscatter data message is based at least in part upon expiration of the timer.

Aspect 10: The method of any of aspects 8 through 9, wherein the first backscatter reading device comprises a first network entity, and the second backscatter reading device comprises a second network entity.

Aspect 11: A method for wireless communications at a first backscatter reading device, comprising: receiving control signaling indicating that the first backscatter reading device is to monitor for backscatter data from a plurality of passive user equipments (UEs); receiving a plurality of backscatter data messages from one or more passive UEs based at least in part on receiving the control signaling; monitoring for feedback signaling, from a network entity, corresponding to one or more of the plurality of backscatter data messages; and forwarding at least a first backscatter data message of the plurality of backscatter data messages to the network entity based at least in part on the monitoring.

Aspect 12: The method of aspect 11, further comprising: receiving, based at least in part on the monitoring, a first feedback message from the network entity indicating that the network entity has successfully received a second backscatter data message of the plurality of backscatter data messages; and discarding the second backscatter data message of the plurality of backscatter data messages based at least in part on the first feedback message.

Aspect 13: The method of aspect 12, wherein the first feedback message comprises a device identifier corresponding to a first passive UE of the plurality of passive UEs, and the discarding is based at least in part on receiving the device identifier.

Aspect 14: The method of any of aspects 11 through 13, further comprising: receiving, based at least in part on the monitoring, a plurality of feedback messages, each feedback message corresponding to a device identifier of a respective passive UE of the plurality of passive UEs; and determining that none of the received feedback messages indicate a device identifier associated with the first backscatter data message, wherein transmitting the first backscatter data message is based at least in part on the determining.

Aspect 15: The method of any of aspects 11 through 14, wherein the first backscatter reading device comprises a UE.

Aspect 16: The method of any of aspects 11 through 15, wherein the control signaling comprises multicast control signaling for a plurality of backscatter reading devices comprising the first backscatter reading device.

Aspect 17: The method of any of aspects 11 through 16, wherein the control signaling comprises unicast control signaling for the first backscatter reading device.

Aspect 18: An apparatus for wireless communications at a first backscatter reading device, comprising a processor; memory coupled with the processor; and instructions stored in the memory and executable by the processor to cause the apparatus to perform a method of any of aspects 1 through 10.

Aspect 19: An apparatus for wireless communications at a first backscatter reading device, comprising at least one means for performing a method of any of aspects 1 through 10.

Aspect 20: A non-transitory computer-readable medium storing code for wireless communications at a first backscatter reading device, the code comprising instructions executable by a processor to perform a method of any of aspects 1 through 10.

Aspect 21: An apparatus for wireless communications at a first backscatter reading device, comprising a processor; memory coupled with the processor; and instructions stored in the memory and executable by the processor to cause the apparatus to perform a method of any of aspects 11 through 17.

Aspect 22: An apparatus for wireless communications at a first backscatter reading device, comprising at least one means for performing a method of any of aspects 11 through 17.

Aspect 23: A non-transitory computer-readable medium storing code for wireless communications at a first backscatter reading device, the code comprising instructions executable by a processor to perform a method of any of aspects 11 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a first backscatter reading device, comprising:
at least one processor; and
memory coupled with at least one processor, the memory storing instructions executable by the at least one processor to cause the first backscatter reading device to:
monitor for backscatter data from a plurality of passive user equipments (UEs), one or more additional backscatter reading devices, or both;
receive, based at least in part on the monitoring, a first backscatter data message from a first passive UE of the plurality of passive UEs via a second backscatter reading device of the one or more additional backscatter reading devices; and
relay the first backscatter data message to a network entity.

2. The apparatus of claim 1, wherein the instructions are further executable by the at least one processor to cause the first backscatter reading device to:
receive, from one or more of the plurality of passive UEs or the one or more additional backscatter reading devices based at least in part on the monitoring, a plurality of backscatter data messages, wherein at least one of the plurality of backscatter data messages comprises a duplicate of the first backscatter data message; and
discard the duplicate of the first backscatter data message, wherein relaying the first backscatter data message to the network entity is based at least in part on the discarding, wherein the first backscatter reading device comprises a first UE and the second backscatter reading device comprises a second UE.

3. The apparatus of claim 2, wherein the instructions are further executable by the at least one processor to cause the first backscatter reading device to:
combine one or more parameters associated with the first backscatter data message and the duplicate of the first backscatter data message for joint decoding by the first backscatter reading device, wherein relaying the first backscatter data message to the network entity is based at least in part on the combining.

4. The apparatus of claim 1, wherein the instructions are further executable by the at least one processor to cause the first backscatter reading device to:
receive, from the network entity, control signaling indicating that the first backscatter reading device is a primary backscatter reading device, wherein receiving the first backscatter data message via the second backscatter reading device is based at least in part on the control signaling indicating that the first backscatter reading device is a primary backscatter reading device.

5. The apparatus of claim 1, wherein the instructions to receive the first backscatter data message from the first passive UE via the second backscatter reading device are executable by the at least one processor to cause the first backscatter reading device to:
receive, from the second backscatter reading device, an indication of a plurality of backscatter data messages received by the second backscatter reading device, the indication further indicating a quantity of passive UEs corresponding to the plurality of backscatter data messages, wherein the plurality of backscatter data messages comprises the first backscatter data message.

6. The apparatus of claim 5, wherein the instructions are further executable by the at least one processor to cause the first backscatter reading device to:
transmit, to the network entity, a request to switch the second backscatter reading device to be a primary backscatter reading device responsive to the quantity of passive UEs corresponding to the plurality of backscatter data messages received by the second backscatter reading device being greater than a second quantity of backscatter data messages received by the first backscatter reading device.

7. The apparatus of claim 5, wherein the instructions are further executable by the at least one processor to cause the first backscatter reading device to:
transmit, to a plurality of additional backscatter reading device comprising the second backscatter reading device, an indication of one or more identifiers associated with respective passive UEs of the quantity of passive UEs corresponding to the plurality of backscatter data messages.

8. The apparatus of claim 1, wherein the instructions are further executable by the at least one processor to cause the first backscatter reading device to:
transmit, to the second backscatter reading device based at least in part on the monitoring, a request for the first backscatter data message, wherein receiving the first backscatter data message from the second backscatter reading device is based at least in part on transmitting the request.

9. The apparatus of claim 8, wherein the instructions are further executable by the at least one processor to cause the first backscatter reading device to:
transmit, to at least the first passive UE via a radio frequency source device, control signaling comprising an instruction to transmit the first backscatter data message;
initiate a timer upon transmitting the control signaling; and
monitor for the first backscatter data message based at least in part on transmitting the control signaling, wherein transmitting the request for the first backscatter data message is based at least in part upon expiration of the timer.

10. The apparatus of claim 8, wherein the first backscatter reading device comprises a first network entity, and the second backscatter reading device comprises a second network entity.

11. An apparatus for wireless communications at a first backscatter reading device, comprising:
at least one processor; and
memory coupled with the at least one processor, the memory storing instructions executable by the at least one processor to cause the first backscatter reading device to:
receive control signaling indicating that the first backscatter reading device is to monitor for backscatter data from a plurality of passive user equipments (UEs);
receive a plurality of backscatter data messages from one or more passive UEs based at least in part on receiving the control signaling;
monitor for feedback signaling, from a network entity, corresponding to one or more of the plurality of backscatter data messages; and
forward at least a first backscatter data message of the plurality of backscatter data messages to the network entity based at least in part on the monitoring.

12. The apparatus of claim 11, wherein the instructions are further executable by the at least one processor to cause the first backscatter reading device to:
receive, based at least in part on the monitoring, a first feedback message from the network entity indicating that the network entity has successfully received a second backscatter data message of the plurality of backscatter data messages; and
discard the second backscatter data message of the plurality of backscatter data messages based at least in part on the first feedback message.

13. The apparatus of claim 12, wherein:
the first feedback message comprises a device identifier corresponding to a first passive UE of the plurality of passive UEs, and
the discarding is based at least in part on receiving the device identifier.

14. The apparatus of claim 11, wherein the instructions are further executable by the at least one processor to cause the first backscatter reading device to:
receive, based at least in part on the monitoring, a plurality of feedback messages, each feedback message corresponding to a device identifier of a respective passive UE of the plurality of passive UEs; and
determine that none of the received feedback messages indicate a device identifier associated with the first backscatter data message, wherein transmitting the first backscatter data message is based at least in part on the determining.

15. The apparatus of claim 11, wherein the first backscatter reading device comprises a UE.

16. The apparatus of claim 11, wherein the control signaling comprises multicast control signaling for a plurality of backscatter reading devices comprising the first backscatter reading device.

17. The apparatus of claim 11, wherein the control signaling comprises unicast control signaling for the first backscatter reading device.

18. A method for wireless communications at a first backscatter reading device, comprising:
monitoring for backscatter data from a plurality of passive user equipments (UEs), one or more additional backscatter reading devices, or both;
receiving, based at least in part on the monitoring, a first backscatter data message from a first passive UE of the plurality of passive UEs via a second backscatter reading device of the one or more additional backscatter reading devices; and
relaying the first backscatter data message to a network entity.

19. The method of claim 18, further comprising:
receiving, from one or more of the plurality of passive UEs or the one or more additional backscatter reading devices based at least in part on the monitoring, a plurality of backscatter data messages, wherein at least one of the plurality of backscatter data messages comprises a duplicate of the first backscatter data message; and
discarding the duplicate of the first backscatter data message, wherein relaying the first backscatter data message to the network entity is based at least in part on the discarding, wherein the first backscatter reading device comprises a first UE and the second backscatter reading device comprises a second UE.

20. The method of claim 19, further comprising:
combining one or more parameters associated with the first backscatter data message and the duplicate of the first backscatter data message for joint decoding by the first backscatter reading device, wherein relaying the first backscatter data message to the network entity is based at least in part on the combining.

21.-30. (canceled)
